(19) United States
(12) Patent Application Publication
(10) Pub. No.: US 2026/0338356 A1
(43) Pub. Date: Oct. 29, 2026

(54) MODULAR LIGHTING SYSTEM

(71) Applicant: Apparatus LLC, New York, NY (US)

(72) Inventor: Gabriel Hendifar, New York, NY (US)

(73) Assignee: Apparatus LLC, New York, NY (US)

(21) Appl. No.: 19/111,925

(22) PCT Filed: Dec. 11, 2024
(86) PCT No.: PCT/US2024/059611

§ 371 Date: Mar. 14, 2025

Related U.S. Application Data
(60) Provisional application No. 63/614,974, filed on Dec. 27, 2023.
(60) Provisional application No. 63/562,317, filed on Mar. 7, 2024.

(51) Int. Cl. F21V 21/02

(52) U.S. Cl. CPC F21V 21/02

(57) ABSTRACT

A modular lighting system that includes mounting plates and canopies that can be adjoined to each other with light fixtures attachable thereto to form a variety of scalable lighting arrangements.

### CROSS-REFERENCE TO RELATED APPLICATION

This patent application claims benefit to U.S. Provisional Patent Application Nos. 63/614,974, filed Dec. 27, 2023 and 63/562,317, filed Mar. 14, 2024, which are hereby incorporated by reference in their entirety as part of the present disclosure.

### FIELD OF THE INVENTION

The present disclosure relates generally to a luminaire and more specifically to a modular lighting system that is configured to be mounted to a surface (e.g., a ceiling, wall or similar structure).

### BACKGROUND OF THE INVENTION

Known modular lighting system come in various shapes and configurations ranging from a single lighting fixture to multiple lighting fixtures that are affixable to a surface (e.g., ceiling, wall or similar structure). However, such modular lighting systems do not allow for seamless and continuous electro-mechanical connectivity between luminaires that can be configured to be an array of possible arrangements utilizing customizable components.

### SUMMARY OF THE INVENTION

In general, the present disclosure is directed to a modular lighting system that includes mounting plates and canopies that can be adjoined to each other with light fixtures attachable thereto to form a variety of scalable lighting arrangements.

In an embodiment, the present disclosure is directed to a modular lighting system that comprises at least one mounting plate, at least one canopy and at least one light source.

The at least one mounting plate can include a main body and a flange extending from each side of the main body in a same direction. The at least one mounting plate includes at least a first mounting plate and a second mounting plate that are configured to be arranged adjacent to each other and fixable to each other.

The at least one canopy can include a main body and a plurality of sidewalls with the sidewalls extending in a same direction from the main body and extending along at least a portion of each side of the main body. The at least one canopy can be configured to be arranged over the least one mounting plate and fixed to the mounting plate. The at least one canopy can include at least a first canopy and a second canopy that are configured to extend over the at least first mounting plate and the second mounting plate, respectively.

The least one light source can be fixed to the at least one canopy.

In another embodiment, the present disclosure is directed to a modular lighting kit, comprising a plurality of mounting plates that are configured to be arranged adjacent to each other, a plurality of canopies that are configured to extend over each of the mounting plates and at least one light source that is fixed to and extends from at least one of the canopies.

In another embodiment, the present disclosure is directed to a method of assembling a modular lighting system comprising the following steps: providing at least one mounting plate, at least one canopy, and at least one light source; fixing the mounting plate to a surface; arranging the canopy over the mounting plate; and fixing the light source to the canopy. The method can further comprise the steps of providing a plurality of mounting plates, a plurality of canopies and at least one light source; fixing a first one of the plurality of mounting plates to the surface; arranging a second one of the plurality of mounting plates adjacent to the first one of the plurality of mounting plates and fixing the second one of the plurality of mounting plates to the surface; arranging a first one of the plurality of canopies over the first one of the plurality of mounting plates and fixing the first one of the plurality of canopies to the first one of the plurality of mounting plates; arranging a second one of the plurality of canopies over the second one of the plurality of mounting plates and fixing the second one of the plurality of canopies to the second one of the plurality of mounting plates; and fixing the light source to one of the plurality of canopies.

### BRIEF DESCRIPTION OF THE DRAWINGS

FIG. 1 is a perspective view of an installation of a modular lighting system according to an embodiment of the present disclosure;

FIGS. 2-5 illustrates various views of a square mounting plate according to an embodiment of the present disclosure;

FIGS. 6-9 illustrates various views of another square mounting plate according to an embodiment of the present disclosure;

FIGS. 10-13 illustrates various views of yet another square mounting plate according to an embodiment of the present disclosure;

FIGS. 14-17 illustrates various views of a corner mounting plate according to an embodiment of the present disclosure;

FIGS. 18-21 illustrates various views of another corner mounting plate according to an embodiment of the present disclosure;

FIGS. 22-24 illustrates various views of a circular mounting plate according to an embodiment of the present disclosure;

FIGS. 25-33 illustrates various views of a substantially square canopy that has two sidewalls according to an embodiment of the present disclosure;

FIGS. 34-42 illustrates various views of a substantially square canopy that has a single sidewall according to embodiments of the present disclosure;

FIGS. 43-51 illustrates various views of another substantially square canopy that has a single sidewall according to embodiments of the present disclosure;

FIGS. 52-60 illustrates various views of another substantially square canopy that has a single sidewall according to embodiments of the present disclosure;

FIGS. 61-69 illustrates various views of a square canopy that has no linearly extending sidewalls according to an embodiment of the present disclosure;

FIGS. 70-76 illustrates various views of a corner canopy according to an embodiment of the present disclosure;

FIGS. 77-84 illustrates various views of another corner canopy according to an embodiment of the present disclosure;

FIG. 85 illustrates an exploded view of a plurality of mounting plates according to an embodiment of the present disclosure;

FIG. 86 illustrates an exploded view of a plurality of canopies that are each associated with a respective one of the mounting plates of FIG. 85 according to an embodiment of the present disclosure;

FIGS. 87-127 illustrate exemplary embodiments of canopy configurations for a modular lighting system according to an embodiment of the present disclosure;

FIGS. 128-136 illustrate exemplary embodiments of light emitting attachments fixable to a canopy for a modular lighting system according to an embodiment of the present disclosure;

FIGS. 134B-134E illustrate various views of the modular lighting system of FIG. 134A;

FIGS. 137A-139D illustrate exemplary embodiments modular lighting system configurations, which are derivations of the modular lighting system depicted in FIGS. 134A-134E according to an embodiment of the present disclosure;

FIGS. 140-151 illustrate exemplary embodiments modular lighting system configurations according to an embodiment of the present disclosure;

FIGS. 152-156 illustrate various views of the modular lighting system assembly of FIG. 137;

FIG. 157 illustrates an exploded assembly view of a modular lighting system according to an embodiment of the present disclosure;

FIGS. 158-162 illustrate various views of the modular lighting system assembly of FIG. 144;

FIGS. 163-167 illustrate various views of the modular lighting system assembly of FIG. 147; and

FIGS. 168-170 illustrate various views of various stages of assembly of embodiments of modular lighting systems.

### DETAILED DESCRIPTION OF EMBODIMENTS OF THE INVENTION

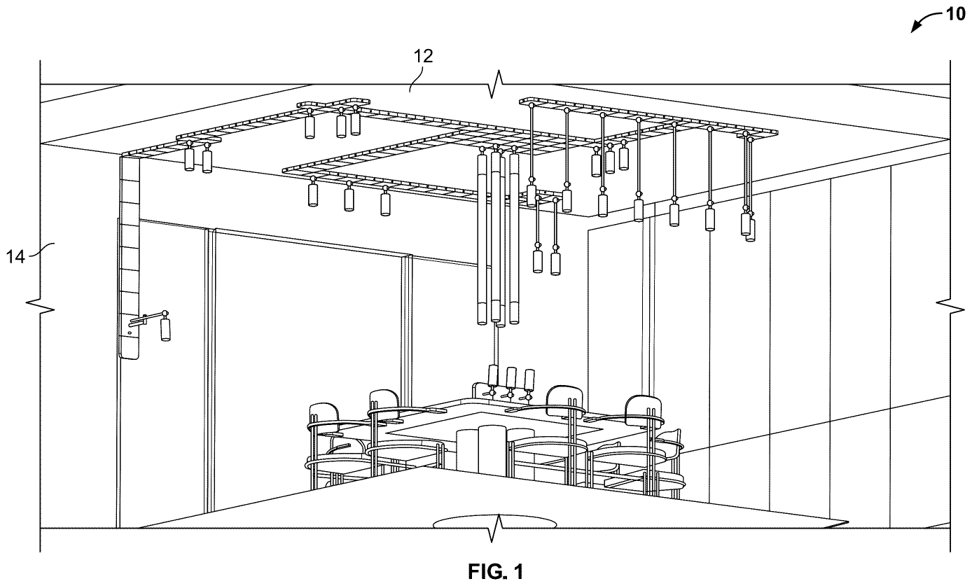

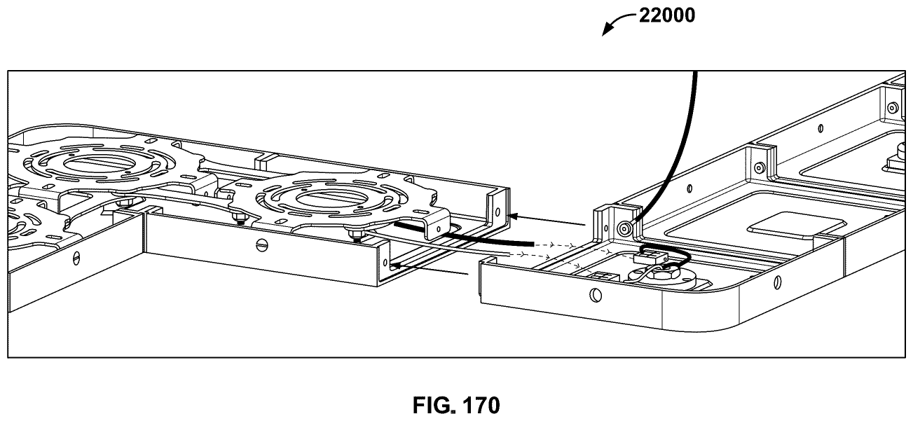

With reference now to the drawings and in particular FIGS. 1-170, embodiments of a modular lighting system of the present disclosure will be described.

FIG. 1 illustrates an embodiment of an installation assembly 10 of various modular lighting system components that will be described in detail below. The installation assembly 10 extends along a (surface (e.g., ceiling) in multiple direction as well as along a second surface (e.g., wall). As can be seen in FIG. 1, a modular lighting system of the present disclosure can include a variety of components to create a desired configuration.

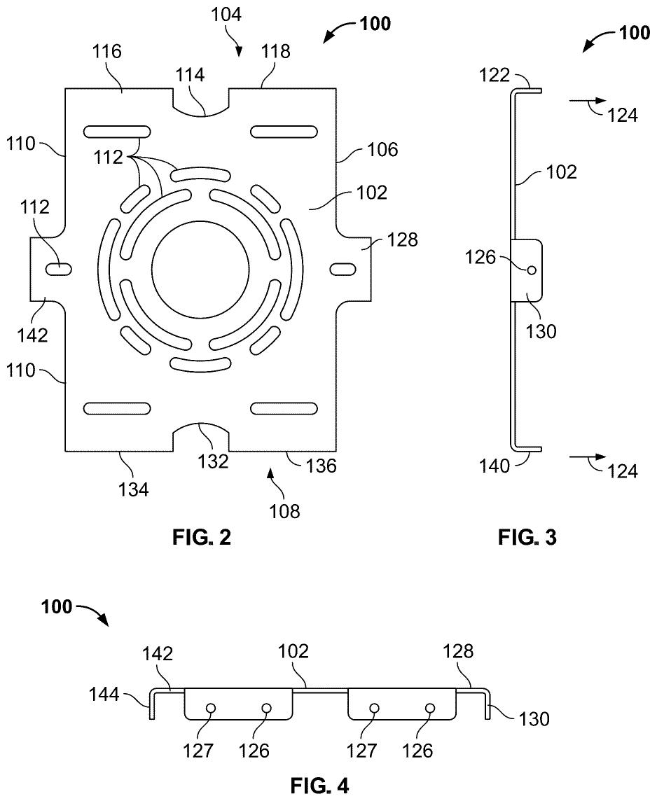

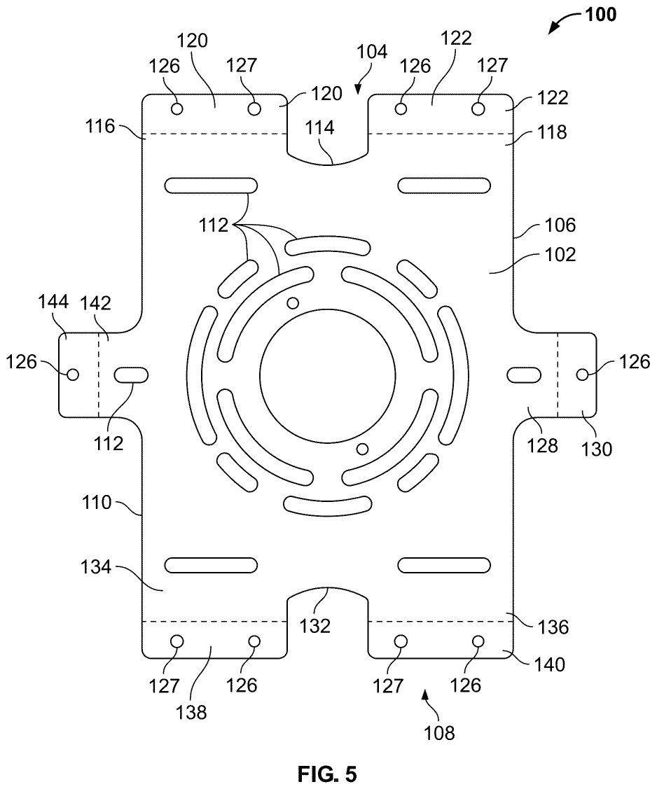

FIGS. 2-5 illustrate a first mounting bracket 100 that is substantially square. The first mounting bracket 100 includes a main body 102 that is delimited by a first side 104, a second side 106, a third side 108 and a fourth side 110, and that has a plurality of cutouts 112 of various sizes and shapes through which fasteners can extend to mount the bracket 100 to a surface and/or through which wires can extend. A first groove 114 extends inwardly from the first side 104 of the main body 102 to form a first projection 116 and a second projection 118. A first flange 120 and a second flange 122 extend from the first projection 116 and the second projection 118, respectively, in a first direction 124 with through holes 126, 127 extending through each of the first flange 120 and the second flange 122. A third projection 128 extends from the second side 106 of the main body 102 and a third flange 130 that includes a through hole 126 that extends from the third projection 128 in the first direction 124. A second groove 132 extends inwardly from the third side 108 of the main body 102 to form a fourth projection 134 and a fifth projection 136. A fourth flange 138 and a fifth flange 140 extend from the fourth projection 134 and the fifth projection 136, respectively, in a first direction 124 with through holes 126, 127 extending through each of the fourth flange 138 and the fifth flange 140. A sixth projection 142 extends from the fourth side 110 of the main body 102 and a sixth flange 144 that includes a through hole 126 extends from the sixth projection 142 in the first direction 124. The flanges 120, 122, 130, 138, 140, 144 can, for example, extend at a 90-degree angle from the main body 102 and the projections 116, 118, 128, 134, 136, 142.

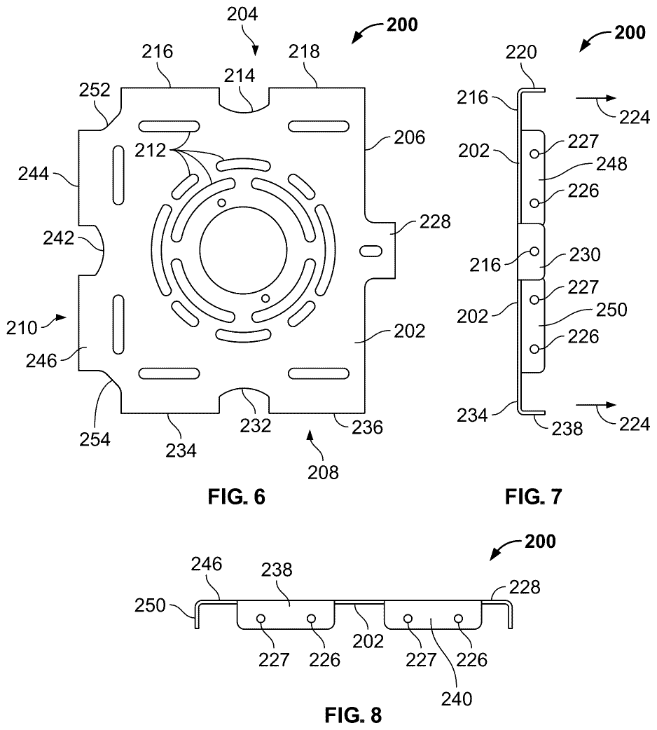

FIGS. 6-9 illustrate a second mounting bracket 200 that is substantially square. The second mounting bracket 200 includes a main body 202 that is delimited by a first side 204, a second side 206, a third side 208 and a fourth side 210, and that has a plurality of cutouts 212 of various sizes and shapes through which fasteners can extend to mount the bracket 200 to a surface and/or wires can extend. A first groove 214 extends inwardly from the first side 204 of the main body 202 to form a first projection 216 and a second projection 218. A first flange 220 and a second flange 222 extend from the first projection 216 and the second projection 218, respectively, in a first direction 224 with through holes 226, 227 extending through each of the first flange 220 and the second flange 222. A third projection 228 extends from the second side 206 of the main body 202. A third flange 230 that includes a through hole 226 extends from the third projection 228 in the first direction 224. A second groove 232 extends inwardly from the third side 208 of the main body 202 to form a fourth projection 234 and a fifth projection 236. A fourth flange 238 and a fifth flange 240 extend from the fourth projection 234 and the fifth projection 236, respectively, in the first direction 224 with through holes 226, 227 extending through each of the fourth flange 238 and the fifth flange 240. A third groove 242 extends inwardly from the fourth side 210 of the main body 202 to form a fourth projection 244 and a fifth projection 246. A sixth flange 248 and a seventh flange 250 extend from the sixth projection 244 and the seventh projection 246, respectively, in the first direction 224 with through holes 226, 227 extending through each of the sixth flange 248 and the seventh flange 250. A first chamfer 252 extends between the first side 204 and the fourth side 210 and second chamfer 254 extends between the third side 208 and the fourth side 210. The flanges 220, 222, 230, 238, 240, 248, 250 can, for example, extend at a 90-degree angle from the main body 202 and the projections 216, 218, 228, 234, 236, 244, 246.

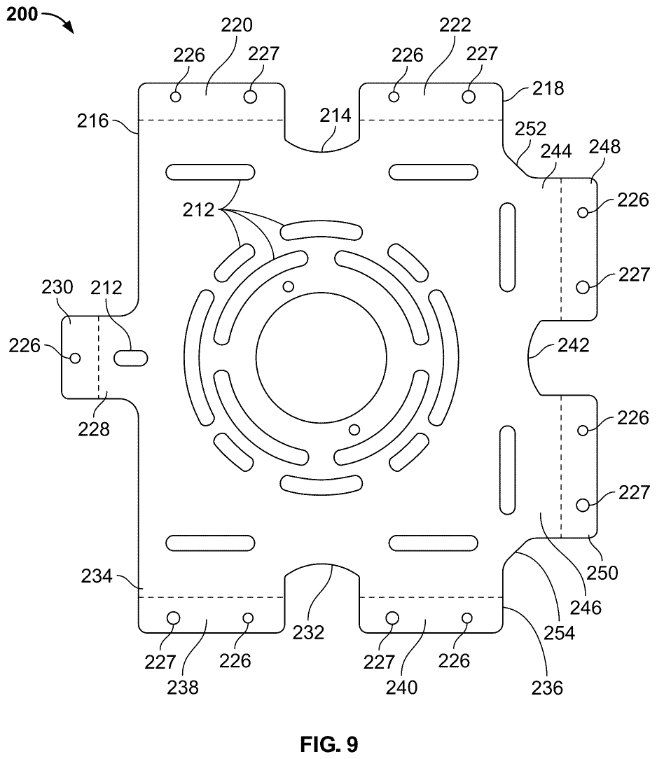

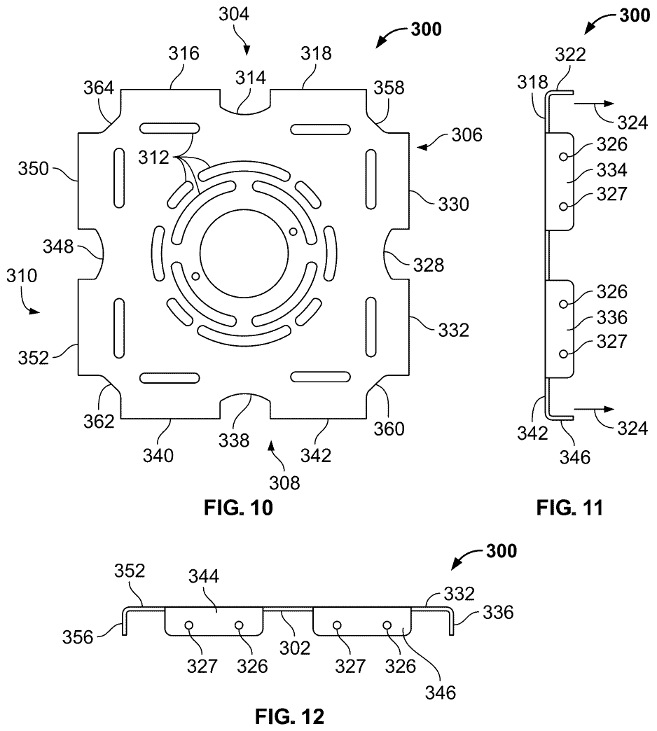

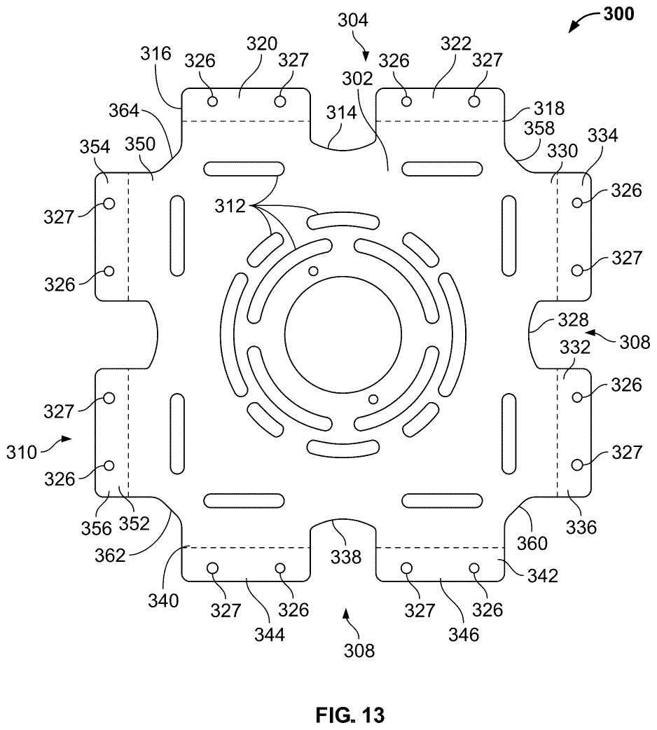

FIGS. 10-13 illustrate a third mounting bracket 300 that is substantially square. The third mounting bracket 300 includes a main body 302 that is delimited by a first side 304, a second side 306, a third side 308 and a fourth side 310, and that has a plurality of cutouts 312 of various sizes and shapes through which fasteners can extend to mount the bracket 300 to a surface and/or wires can extend. A first groove 314 extends inwardly from the first side 304 of the main body 302 to form a first projection 316 and a second projection 318. A first flange 320 and a second flange 322 extend from the first projection 316 and the second projection 318, respectively, in a first direction 324 with through holes 326, 327 extending through each of the first flange 320 and the second flange 322. A second groove 328 extends inwardly from the second side 306 of the main body 302 to form a third projection 330 and a fourth projection 332. A third flange 334 and a fourth flange 336 extend from the third projection 330 and the fourth projection 332, respectively, in the first direction 324 with through holes 326, 327 extending through each of the third flange 334 and the fourth flange 336. A third groove 338 extends inwardly from the third side 308 of the main body 302 to form a fifth projection 340 and a sixth projection 342. A fifth flange 344 and a sixth flange 346 extend from the fifth projection 340 and the sixth projection 342, respectively, in the first direction 324 with through holes 326, 327 extending through each of the fifth flange 344 and the sixth flange 346. A fourth groove 348 extends inwardly from the fourth side 310 of the main body 302 to form a seventh projection 350 and an eighth projection 352. A seventh flange 354 and an eighth flange 356 extend from the seventh projection 350 and the eighth projection 352, respectively, in the first direction 324 with through holes 326, 327 extending through each of the seventh flange 354 and the eighth flange 356. A first chamfer 358 extends between the first side 304 and the second side 306, a second chamfer 360 extends between the second side 306 and the third side 308, a third chamfer 362 extends between the third side 308 and the fourth side 310 and a fourth chamfer 364 extends between the fourth side 310 and the first side 304. The flanges 320, 322, 334, 336, 344, 346, 354, 356 can, for example, extend at a 90-degree angle from the main body 302 and the projections 316, 318, 330, 332, 340, 342, 350, 252.

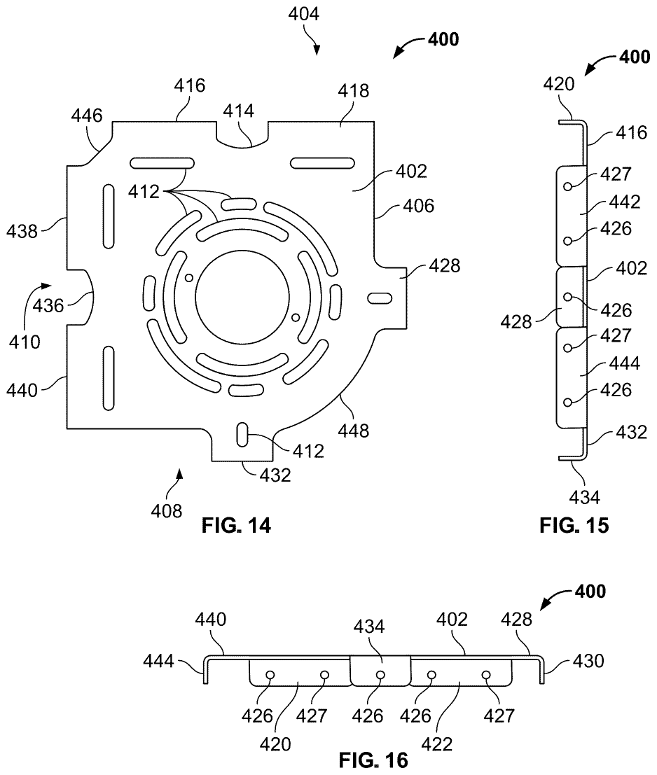

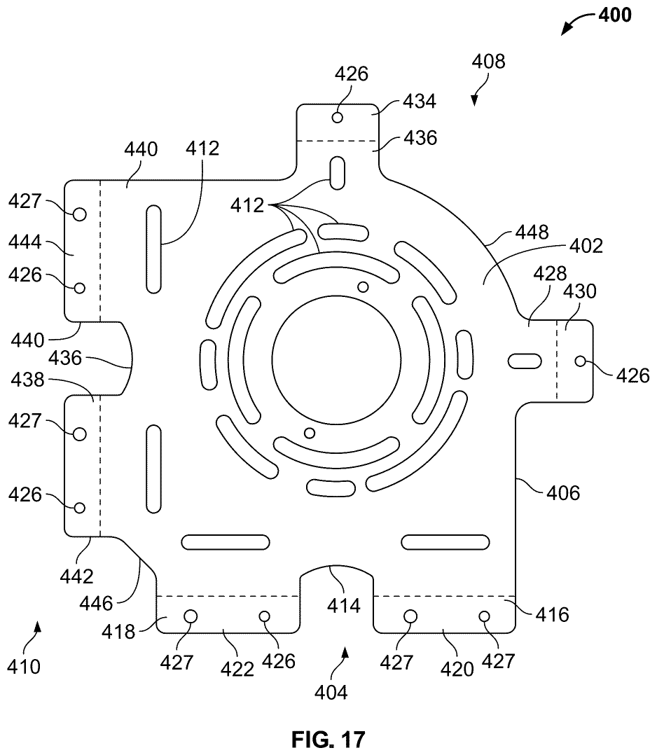

FIGS. 14-17 illustrate a fourth mounting bracket 400 that includes a rounded corner. The fourth mounting bracket 400 includes a main body 402 that is delimited by a first side 404, a second side 406, a third side 408 and a fourth side 410, and that has a plurality of cutouts 412 of various sizes and shapes through which fasteners can extend to mount the bracket 400 to a surface and/or wires can extend. A first groove 414 extends inwardly from the first side 404 of the main body 402 to form a first projection 416 and a second projection 418. A first flange 420 and a second flange 422 extend from the first projection 416 and the second projection 418, respectively, in a first direction 424 with through holes 426, 427 extending through each of the first flange 420 and the second flange 422. A third projection 428 extends from the second side 406 of the main body 402. A third flange 430 that includes a through hole 426 extends from the third projection 428 in the first direction 424. A fourth projection 432 extends from the third side 408 of the main body 402. A fourth flange 434 that includes a through hole 426 extends from the fourth projection 434 in the first direction 424. A second groove 436 extends inwardly from the fourth side 410 of the main body 402 to form a fifth projection 438 and a sixth projection 440. A fifth flange 442 and a sixth flange 444 extend from the fifth projection 438 and a sixth projection 440, respectively, in the first direction 424 with through holes 426, 427 extending through each of the fifth flange 442 and a sixth flange 444. A chamfered corner 446 extends between the first side 404 and the fourth side 410 and rounded corner 448 extends between the second side 406 and the third side 408. The flanges 420, 422, 430, 436, 444, 446 can, for example, extend at a 90-degree angle from the main body 402 and the projections 416, 418, 428, 432, 440, 444.

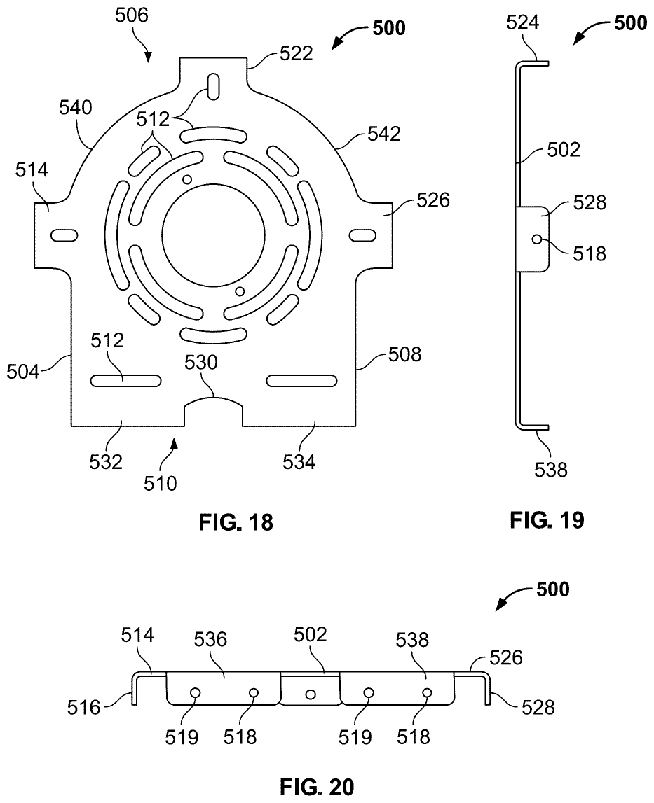

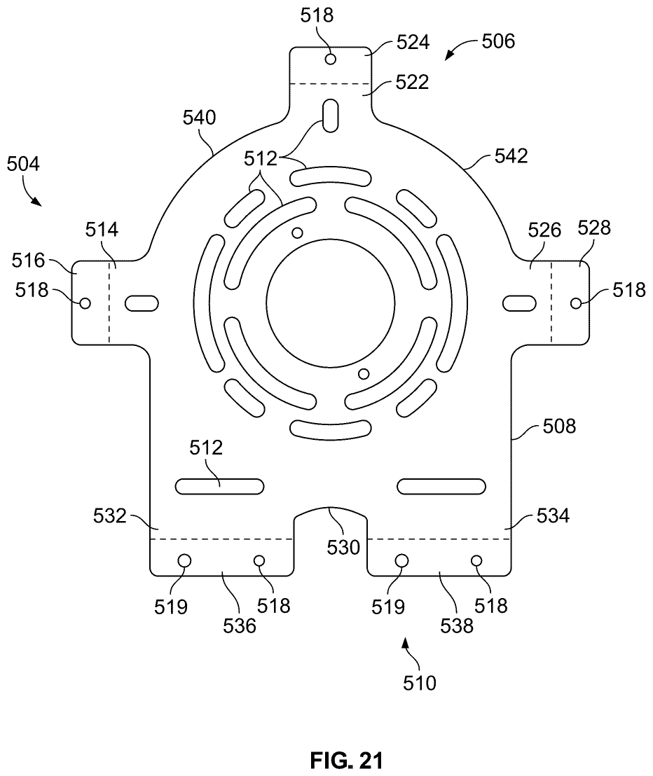

FIGS. 18-21 illustrate a fifth mounting bracket 500 (end bracket) that includes rounded corners. The fifth mounting bracket 500 includes a main body 502 that is delimited by a first side 504, a second side 506, a third side 508 and a fourth side 510, and that has a plurality of cutouts 512 of various sizes and shapes through which fasteners can extend to mount the bracket 500 to a surface and/or wires can extend. A first projection 514 extends from the first side 504 of the main body 502, and a first flange 516 that includes a through hole 518 extends from the first projection 514 in a first direction 520. A second projection 522 extends from the second side 506 of the main body 502, and a second flange 524 that includes a through hole 518 extends from the second projection 522 in the first direction 520. A third projection 526 extends from the third side 508 of the main body 502, and a third flange 528 that includes a through hole 518 extends from the third projection 526 in the first direction 520. A groove 530 extends inwardly from the fourth side 510 of the main body 502 to form a fourth projection 532 and a fifth projection 534. A fourth flange 536 and a fifth flange 538 extend from the fourth projection 532 and a fifth projection 534, respectively, in the first direction 520 with through holes 518, 519 extending through each of the fourth flange 536 and a fifth flange 538. A first rounded corner 540 extends between the first side 504 and the second side 506 and a second rounded corner 542 extends between the second side 506 and the third side 508. The flanges 516, 524,528, 536, 528 can, for example, extend at a 90-degree angle from the main body 402 and the projections 514, 522, 526, 532, 534.

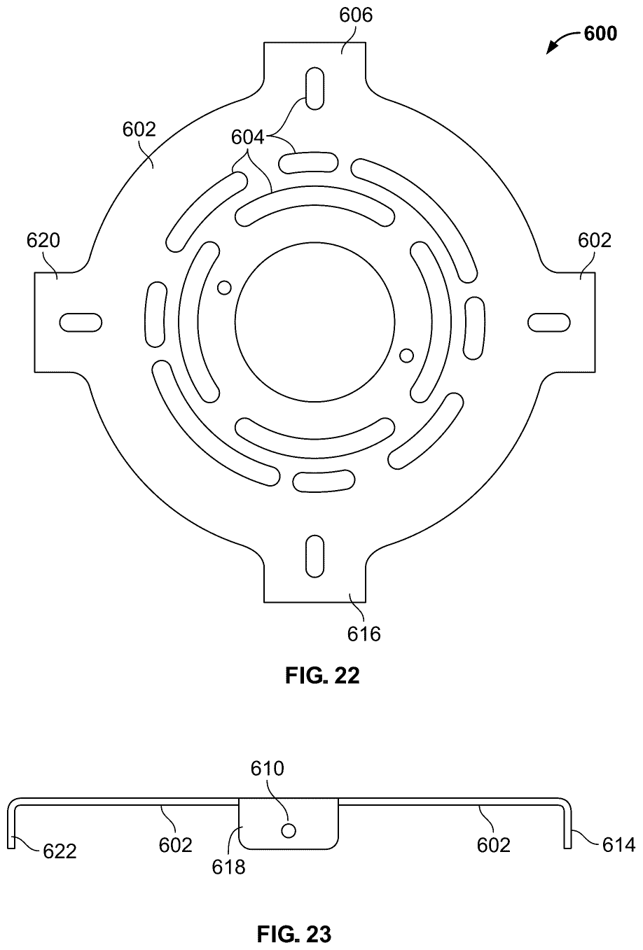

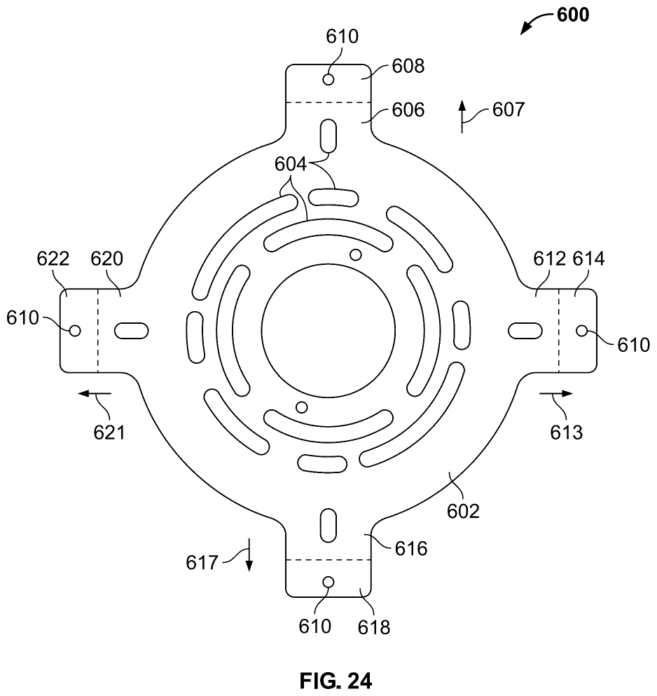

FIGS. 22-24 illustrate a sixth mounting bracket 600 (single bracket) that is circular. The sixth mounting bracket 600 includes a main body 602 that has a plurality of cutouts 604 of various sizes and shapes through which fasteners can extend to mount the bracket 600 to a surface and/or wires can extend. A first projection 606 extend from the main body 602 in a first direction 607, and a first flange 608 that includes a through hole 610 extends at an angle from the first projection 606. A second projection 612 extend from the main body 602 in a second direction 613, and a second flange 614 that includes a through hole 610 extends at an angle from the second projection 612. A third projection 616 extend from the main body 602 in a third direction 617, and a third flange 618 that includes a through hole 610 extends at an angle from the third projection 616. A fourth projection 620 extend from the main body 602 in a fourth direction 621, and a fourth flange 622 that includes a through hole 610 extends at an angle from the fourth projection 620. The projections 606, 612, 616, 620 can extend, for example, at approximately 90 degrees from each other such that the projections 606, 612, 616, 620 extend equidistant about the circular main body 602. The flanges 608, 614, 618, 622 can, for example, extend at a 90-degree angle from the main body 402 and the projections 606, 612, 616, 620.

All of the mounting brackets can, for example, be made of galvanized steel.

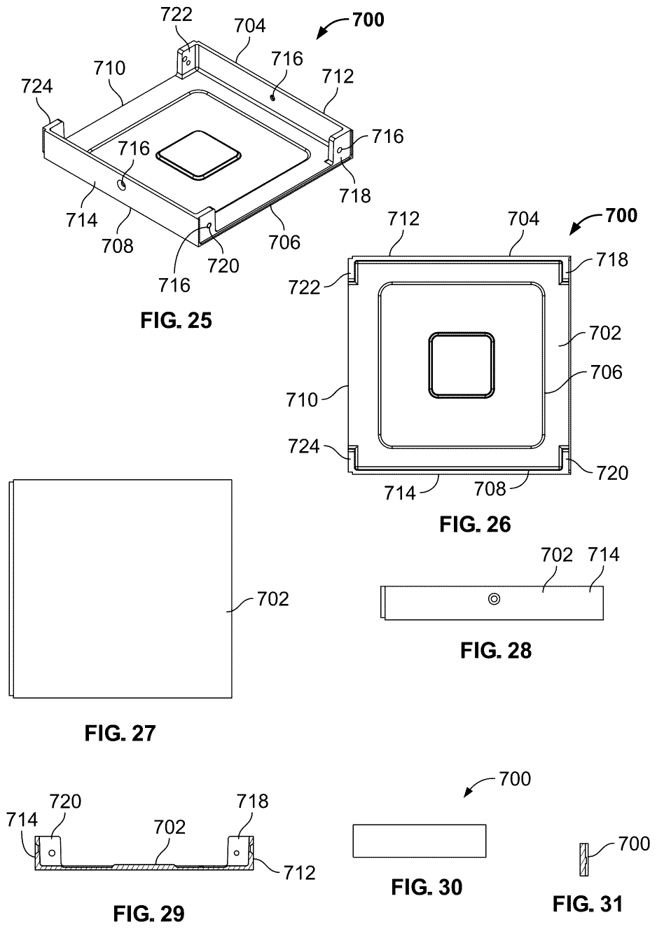

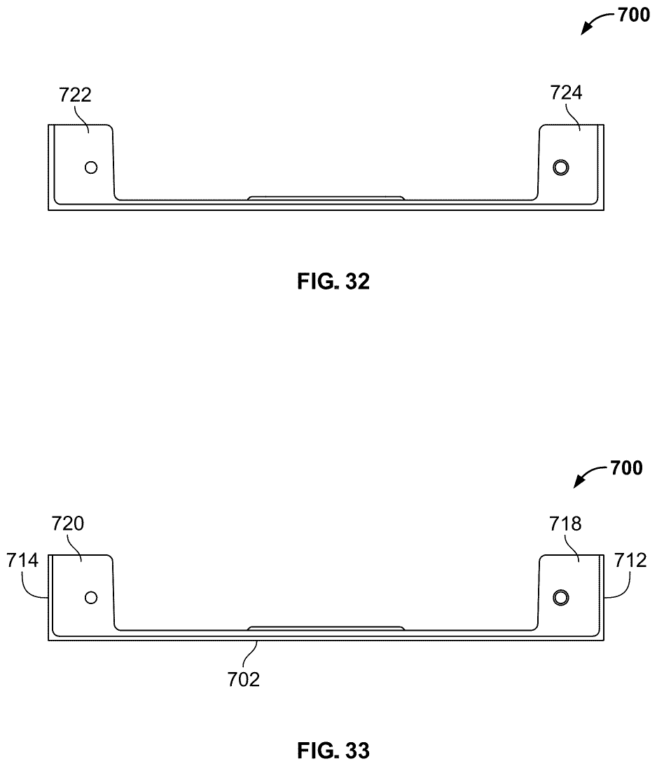

FIGS. 25-33 illustrate a first canopy 700. The first canopy 700 includes a main body 702 that is delimited by a first side 704, a second side 706, a third side 708 and a fourth side 710. The first side 704 includes a sidewall 712 that extends from a first end thereof to a second end thereof and the third side 708 includes a sidewall 714 that extends from a first end thereof to a second end thereof. A through hole 716 extends through each of the sidewalls 712, 714. The second side 706 and the fourth side 710 do not include sidewalls that extends from a first end thereof to a second end thereof. The second side 706 includes a first wall 718 that is recessed from and extends perpendicular to the sidewall 712 of the first side 704 and a second wall 720 that is recessed from and extends perpendicular to the sidewall 714 of the third side 708. Each of the walls 718, 720 of the second side 706 include a through hole 716 that extends therethrough. The fourth side 710 includes a first wall 722 that is recessed from and extends perpendicular to the sidewall 712 of the first side 704 and a second wall 724 that is recessed from and extends perpendicular to the sidewall 714 of the third side 708. Each of the walls 722, 724 of the fourth side 710 include a through hole 716 that extends therethrough.

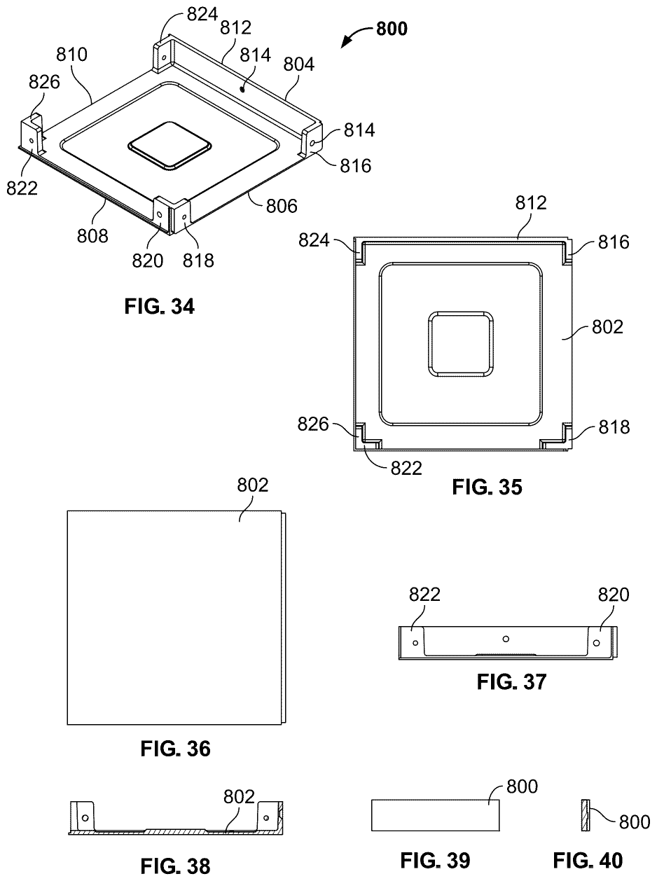

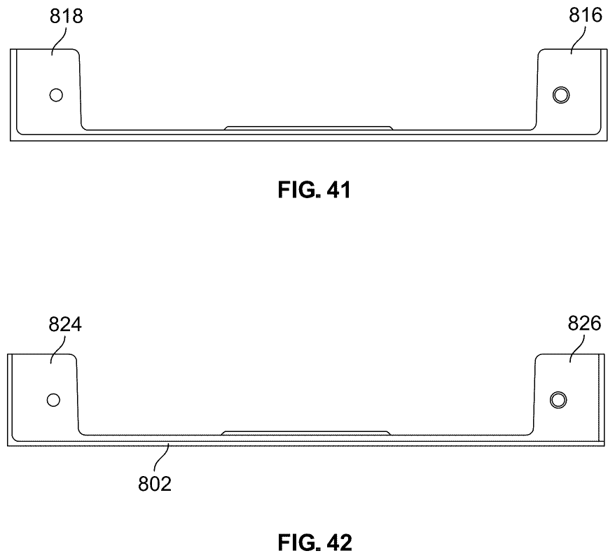

FIGS. 34-42 illustrate a second canopy 800. The second canopy 800 includes a main body 802 that is delimited by a first side 804, a second side 806, a third side 808 and a fourth side 810. The first side 804 includes a sidewall 812 that extends from a first end thereof to a second end thereof. A through hole 814 extends through the sidewalls 812. The second side 806, the third side 808 and the fourth side 810 do not include sidewalls that extends from a first end thereof to a second end thereof. The second side 806 includes a first wall 816 that extends perpendicular to the sidewall 812 of the first side 804 and a second wall 818 that is spaced from the first sidewall 816. The first wall 816 and the second wall 818 extend flush to the edge of the main body 802. The third side 808 includes a first wall 820 that is recessed from and extends perpendicular to the first wall 816 of the second side 806 and a second wall 822 that is spaced from the first wall 816. The fourth side 810 includes a first wall 824 that is recessed from and extends perpendicular to the first wall 820 of the third side 808 and a second wall 826 that is spaced from the first wall 820 and is perpendicular to the sidewall 812 of the first side 804. Each of the walls 816, 818, 820, 822, 824, 826 include a through hole 814 that extends therethrough.

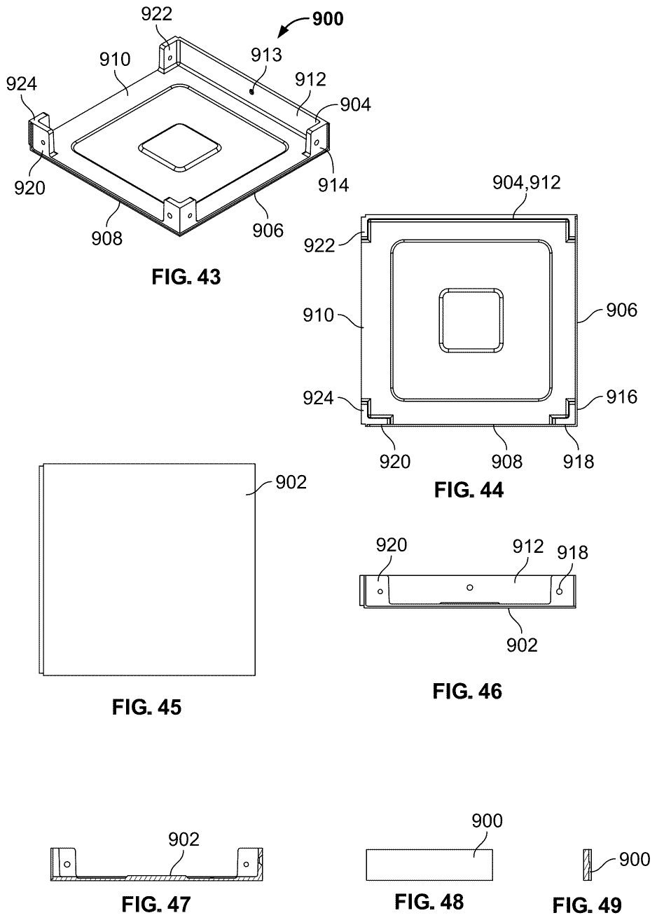

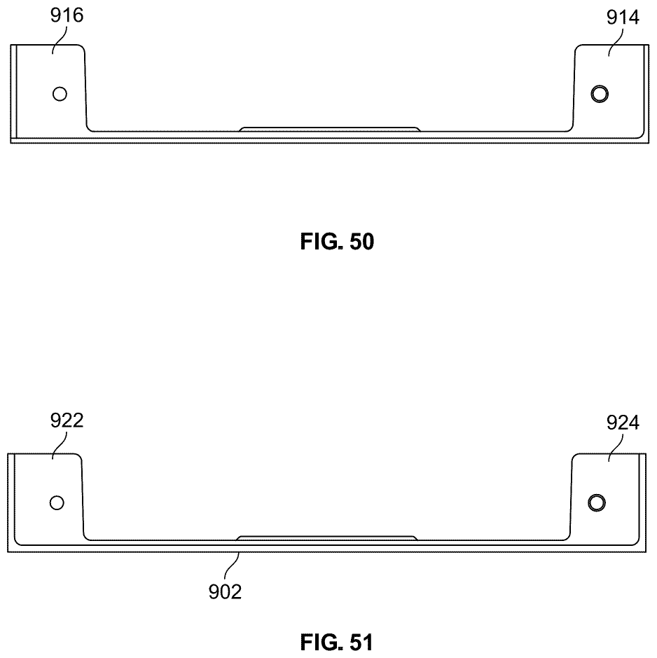

FIGS. 43-51 illustrate a third canopy 900. The third canopy 900 includes a main body 902 that is delimited by a first side 904, a second side 906, a third side 908 and a fourth side 910. The first side 904 includes a sidewall 912 that extends from a first end thereof to a second end thereof. A through hole 913 extends through the sidewalls 912. The second side 906, the third side 908 and the fourth side 910 do not include sidewalls that extends from a first end thereof to a second end thereof. The second side 906 includes a first wall 914 extends perpendicular to the sidewall 912 of the first side 904 and a second wall 916 that is spaced from the first wall 914. The first wall 914 and the second wall 916 are recessed from the edge of the main body 902. The third side 908 includes a first wall 918 extends perpendicular to the second wall 916 of the second side 908 and a second wall 920 that is spaced from the first wall 918. The first wall 914 and the second wall 916 of the second side 906 and the first wall 918 and the second wall 920 of the third side 908 are recessed from the outer edge of the main body 902 along the second side 906 and third side 908, respectively. The fourth side 910 includes a first wall 922 that is perpendicular to the second wall 920 of the third side 908 and a second wall 924 that is spaced from the first wall 922 and extends perpendicular to the sidewall 912. The first wall 922 and the second wall 924 extend flush to the edge of the main body 902. Each of the walls 914, 916, 918, 920, 922, 924 include a through hole 914 that extends therethrough.

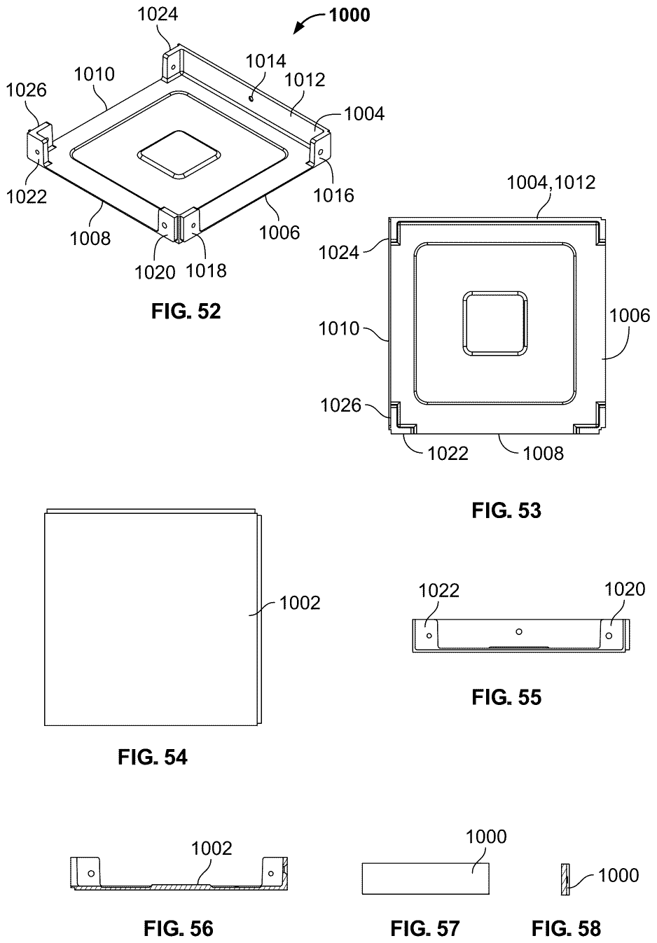

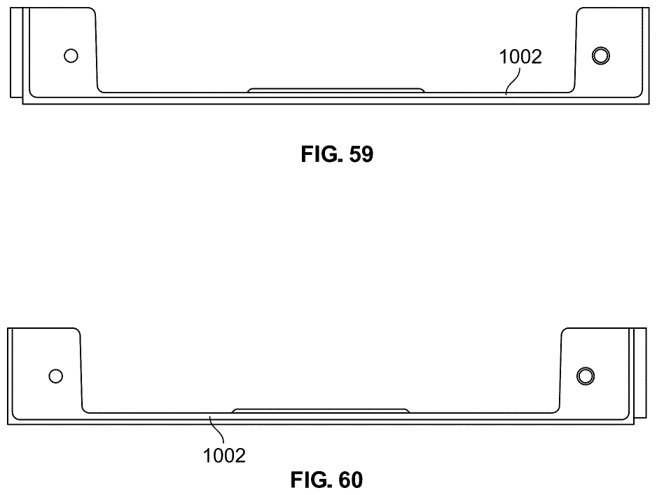

FIGS. 52-60 illustrate a fourth canopy 1000. The fourth canopy 1000 includes a main body 1002 that is delimited by a first side 1004, a second side 1006, a third side 1008 and a fourth side 1010. The first side 1004 includes a sidewall 1012 that extends from a first end thereof to a second end thereof. A through hole 1014 extends through the sidewalls 1012. The second side 1006, the third side 1008 and the fourth side 1010 do not include sidewalls that extends from a first end thereof to a second end thereof. The second side 1006 includes a first wall 1014 extends perpendicular to the sidewall 1012 of the first side 1004 and a second wall 1016 that is spaced from the first wall 1014. The first wall 1014 and the second wall 1016 extend flush to the edge of the main body 1002. The third side 1008 includes a first wall 1018 extends perpendicular to the second wall 1016 of the second side 1008 and a second wall 1020 that is spaced from the first wall 91018. The first wall 114 and the second wall 1016 of the second side 1006 and the first wall 1018 and the second wall 1020 of the third side 1008 extend flush to the edge of the outer edge of the main body 1002 along the second side 1006 and third side 1008, respectively. The fourth side 1010 includes a first wall 1022 that is perpendicular to the second wall 1020 of the third side 1008 and a second wall 1024 that is spaced from the first wall 1022 and extends perpendicular to the sidewall 1012. The first wall 1022 and the second wall 1024 are recessed from the edge of the main body 1002. Each of the walls 1014, 1016, 1018, 1020, 1022, 1024 include a through hole 1014 that extends therethrough.

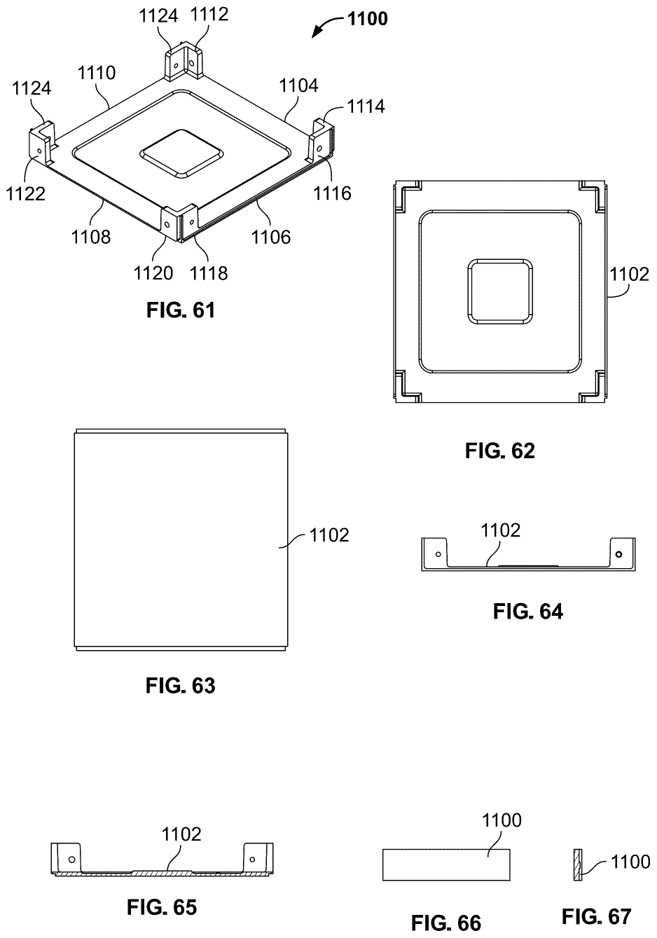

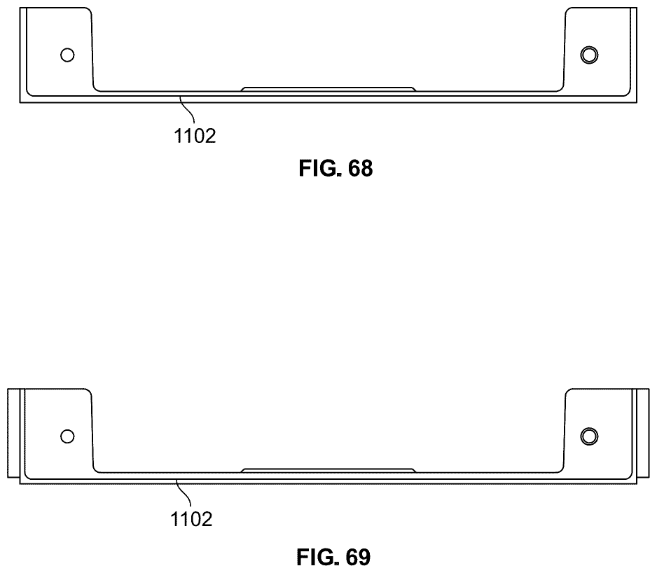

FIGS. 61-69 illustrate a fifth canopy 1100. The fifth canopy 1100 includes a main body 1102 that is delimited by a first side 1104, a second side 1106, a third side 1108 and a fourth side 1110. The first side 1104, the second side 1106, the third side 1108 and the fourth side 1110 do not include sidewalls that extends from a first end thereof to a second end thereof. The first side 1104 includes a first wall 1112 at a first end thereof and a second wall 1114 that is spaced from the first wall 1112 at a second end thereof. The second side 1106 includes a first wall 1116 that extends perpendicular to the second wall 1114 of the first side 1104 and a second wall 1118 that is spaced from the first wall 1116. The third side 1108 includes a first wall 1120 that extends perpendicular to the second wall 1118 of the second side 1108 and a second wall 1122 that is spaced from the first wall 1120. The fourth side 1110 includes a first wall 1124 that extends perpendicular to the second wall 1122 of the third side 1108 and a second wall 1126 that is spaced from the first wall 1124 and extends perpendicular to the first wall 1112 of the first side 1104.

The first wall 1112 and the second wall 1114 of the first side 1104 and the first wall 1120 and the second wall 1122 of the third side 1008 extend flush to the edge of the outer edge of the main body 1102 along the first side 1104 and third side 1008, respectively. The first wall 1116 and the second wall 1118 of the second side 1106 and the first wall 1124 and the second wall 1126 of the fourth side 1110 are recessed the edge of the outer edge of the main body 1102 along the second side 1106 and fourth side 1110, respectively. Each of the walls 1112, 1114, 1116, 1118, 1120, 1122, 1124, 1126 include a through hole 1128 that extends therethrough.

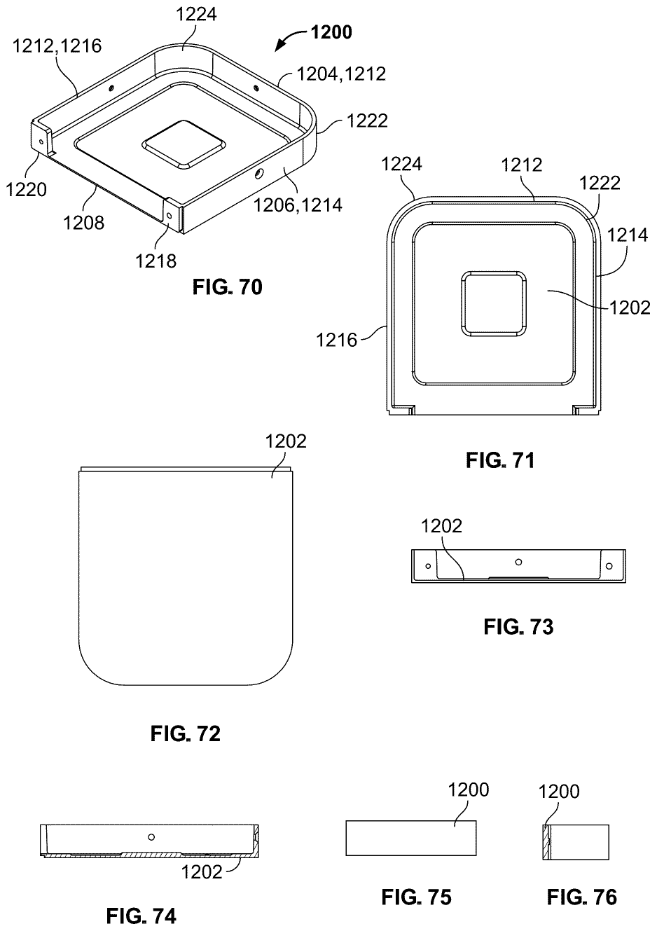

FIGS. 70-76 illustrate a sixth canopy 1200. The sixth canopy 1200 includes a main body 1202 that is delimited by a first side 1204, a second side 1206, a third side 1208 and a fourth side 1210. The first side 1204 includes a sidewall 1212 that extends from a first end thereof to a second end thereof. The second side 1206 includes a sidewall 1214 that extends from a first end thereof to a second end thereof. The fourth side 1210 includes a sidewall 1216 that extends from a first end thereof to a second end thereof. The third side 1208 includes a first wall 1218 that extends perpendicular to the sidewall 1214 of the second side 1206 and a second wall 1220 that is perpendicular to the sidewall 1216 of the fourth side 1210. The first wall 1218 and second wall 1220 extend flush with the outer periphery of the main body 1202 along the third side 1208. Extending between the sidewall 1212 of the first side 1204 and the sidewall 1216 of the fourth side 1210 is a first rounded corner 1222 and extending between the sidewall 1212 of the first side 1204 and the sidewall 1214 of the second side 1206 is a second rounded corner 1224. Each of the sidewalls 1212, 1214, 1216 and walls 1218, 1220 include a through hole 1226 that extends therethrough.

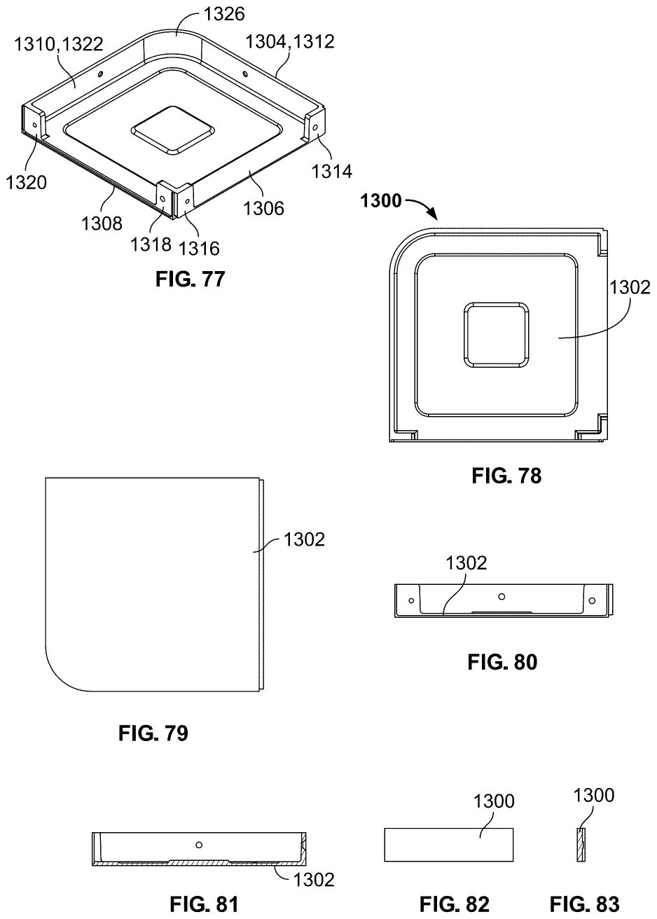

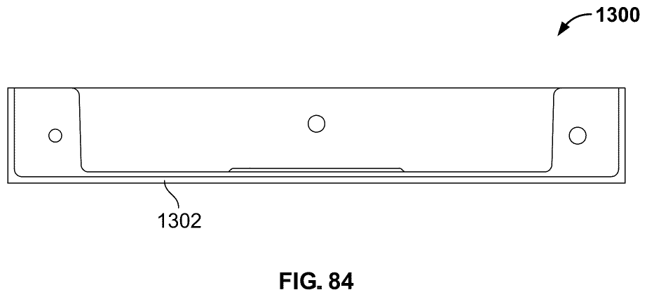

FIGS. 77-84 illustrate a seventh canopy 1300. The seventh canopy 1300 includes a main body 1302 that is delimited by a first side 1304, a second side 1306, a third side 1308 and a fourth side 1310. The first side 1304 includes a sidewall 1312 that extends from a first end thereof to a second end thereof. The second side 1306 includes a first wall 1314 that extends perpendicular to the sidewall 1312 of the first side 1304 and a second wall 1316 that is spaced from the first wall 1314. The first wall 1314 and second wall 1316 extend flush with the outer periphery of the main body 1202 along the second side 1306. The third side 1308 includes a first wall 1318 that extends perpendicular to the second wall 1316 of the second side 1306 and a second wall 1320 that is spaced from the first wall 1318. The first wall 1318 and second wall 1320 are recessed from the outer periphery of the main body 1202 along the third side 1308. The fourth side 1310 includes a sidewall 1322 that extends from a first end thereof to a second end thereof. The fourth side 1310 includes a sidewall 1324 that extends from a first end thereof to a second end thereof. Extending between the sidewall 1312 of the first side 1304 and the sidewall 1322 of the fourth side 1310 is a rounded corner 1326. Each of the sidewalls 1312, 1324 and walls 1314, 1316, 1318, 1320 include a through hole 1328 that extends therethrough.

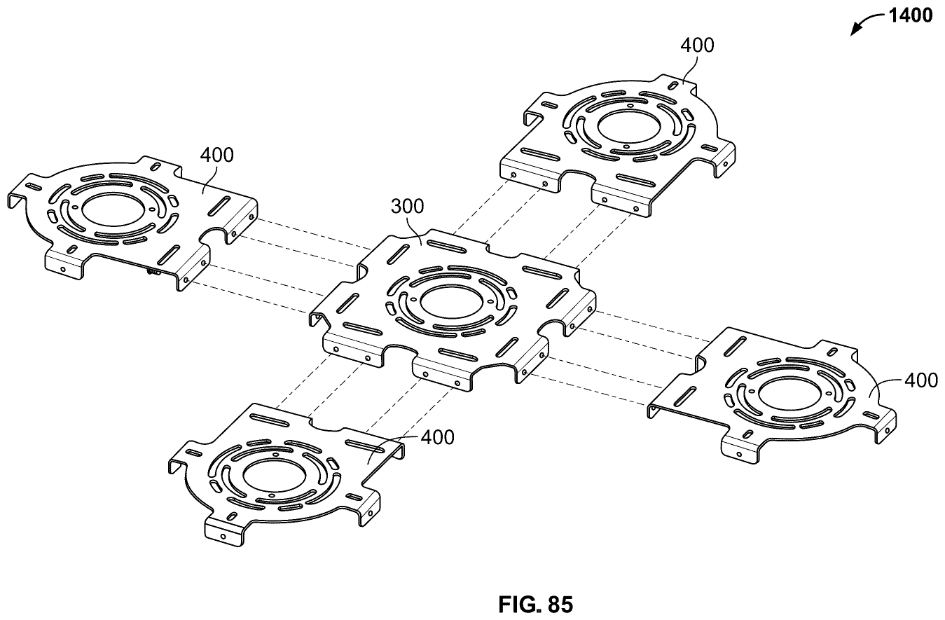

FIG. 85 depicts an exemplary assembly 1400 view of mounting brackets 300, 400. As can be seen, the brackets 300, 400 are connected by fasteners that extend through openings in the flanges of the brackets 300, 400 to fix the brackets 300, 400 to each other.

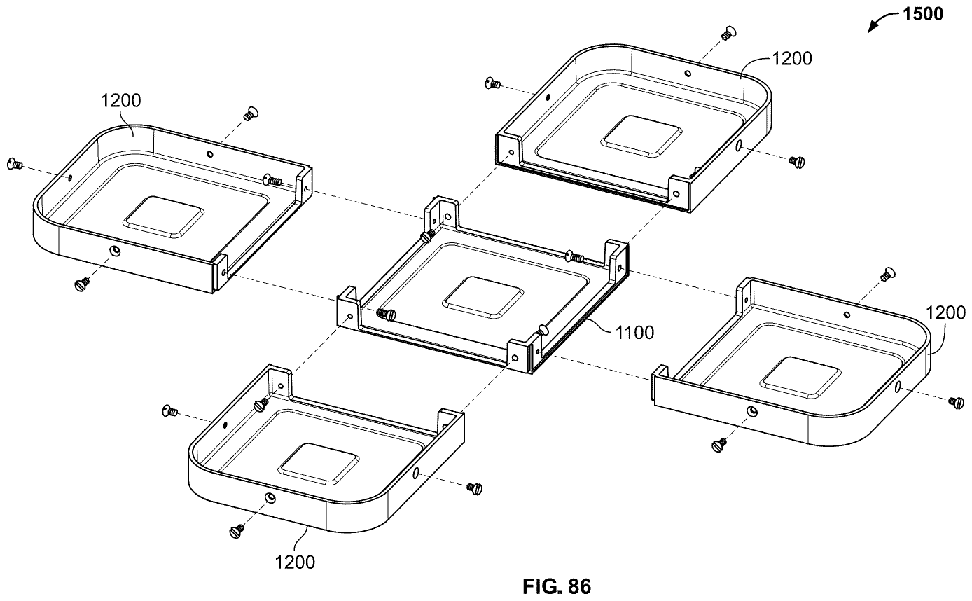

FIG. 86 depicts an exemplary assembly 1500 view of canopies. As can be seen, the canopies 1100, 1200 are connected by fasteners that extend through openings in the canopies 1100, 1200 to fix the brackets to each other.

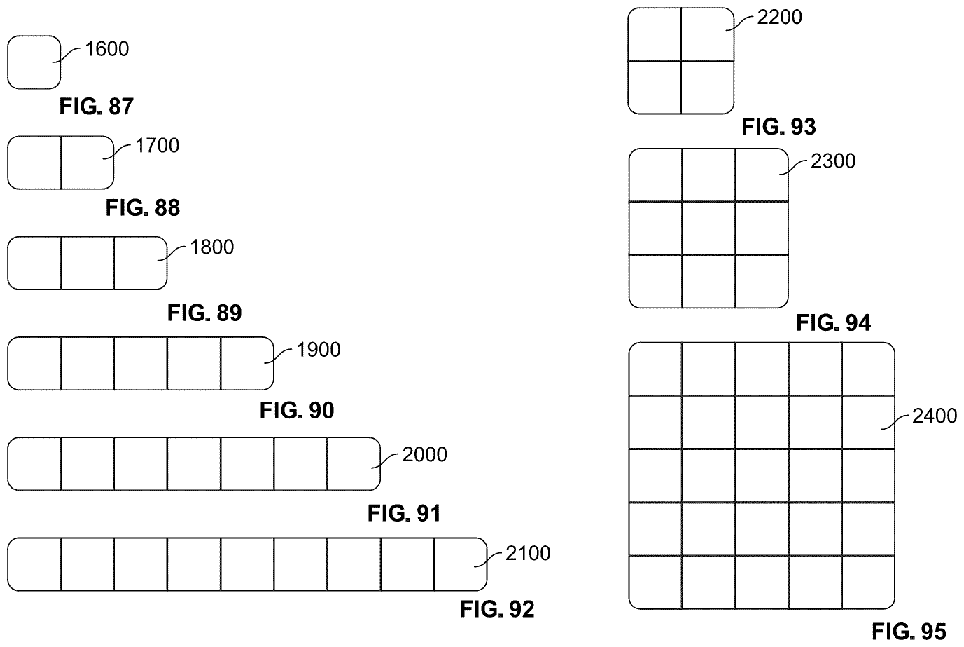

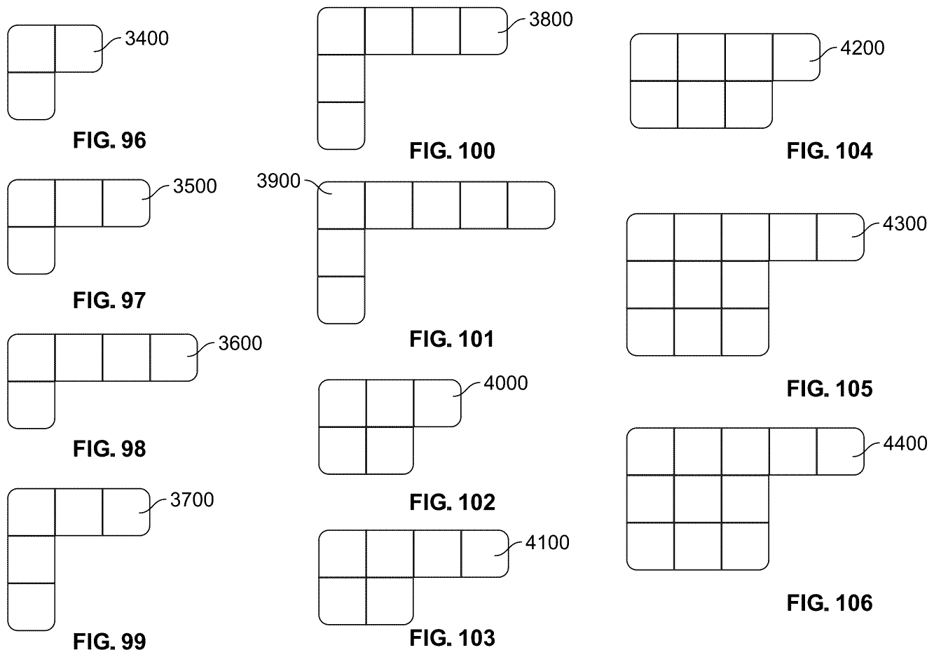

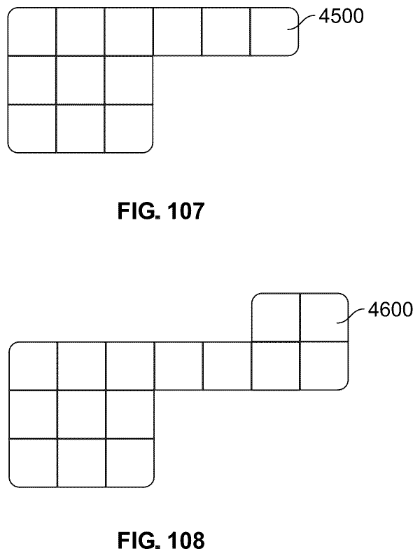

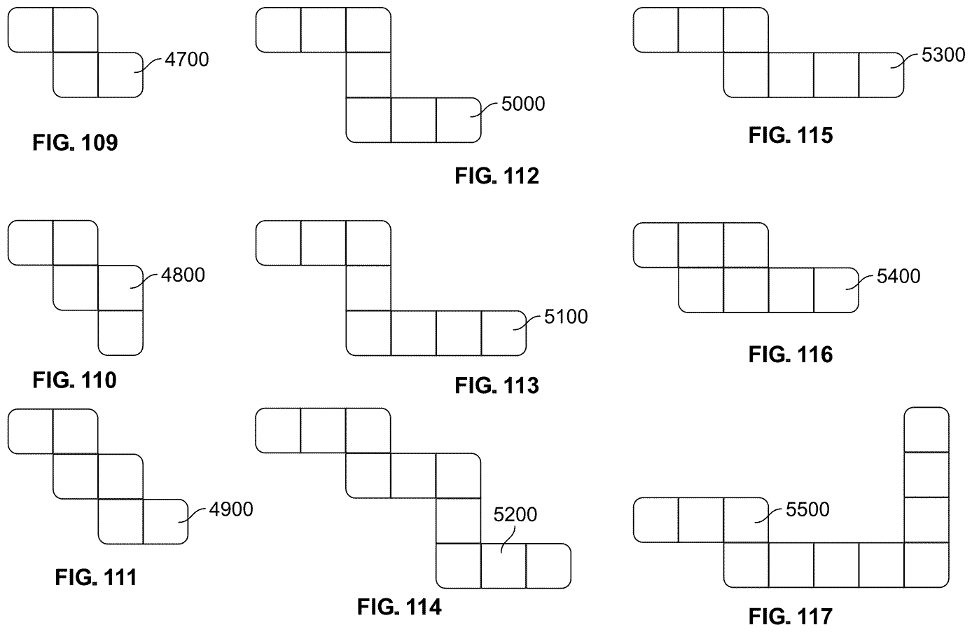

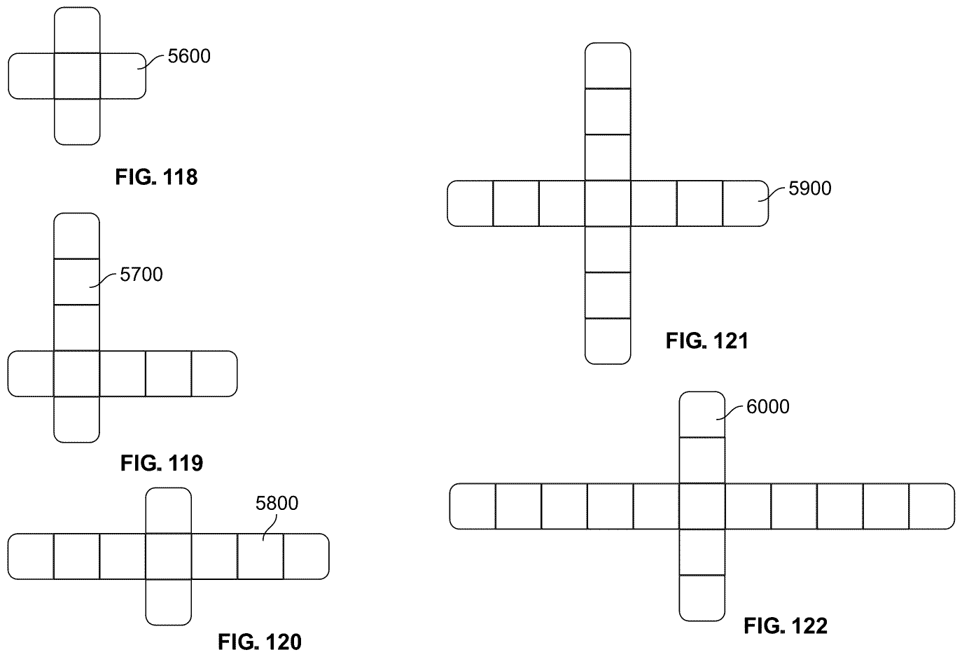

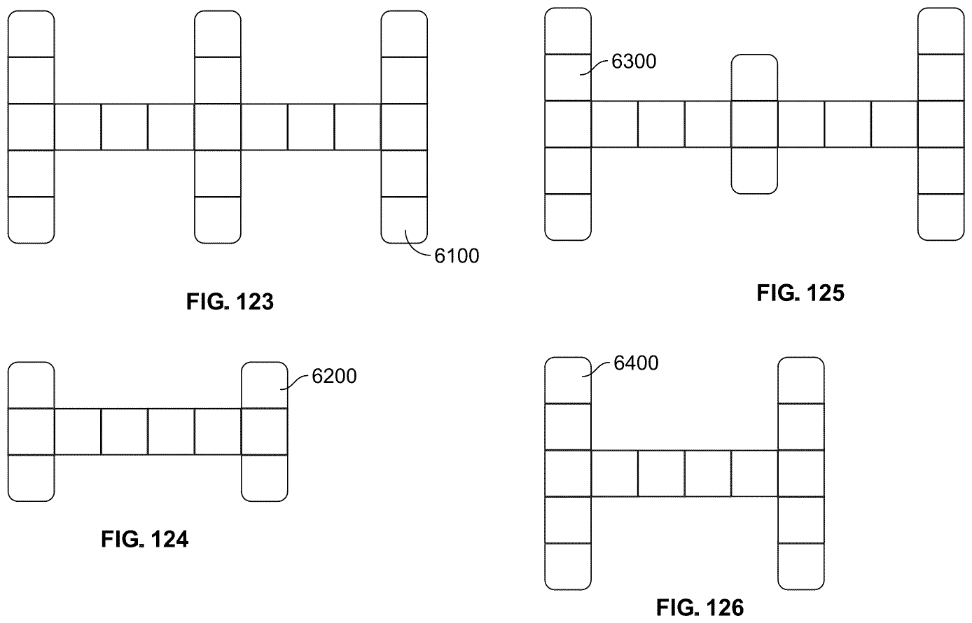

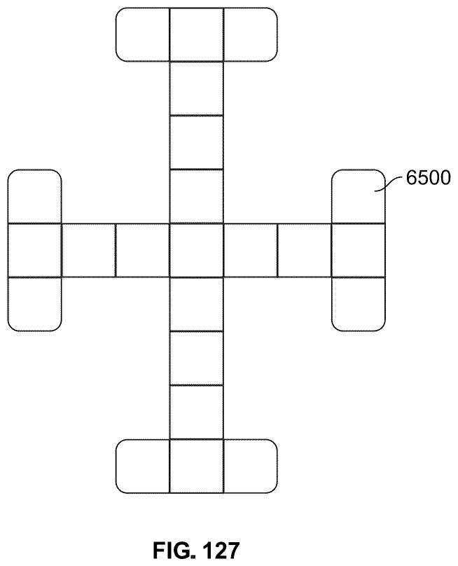

FIGS. 87-127 illustrate embodiments of various canopy configurations 1600-6500 for modular lighting systems.

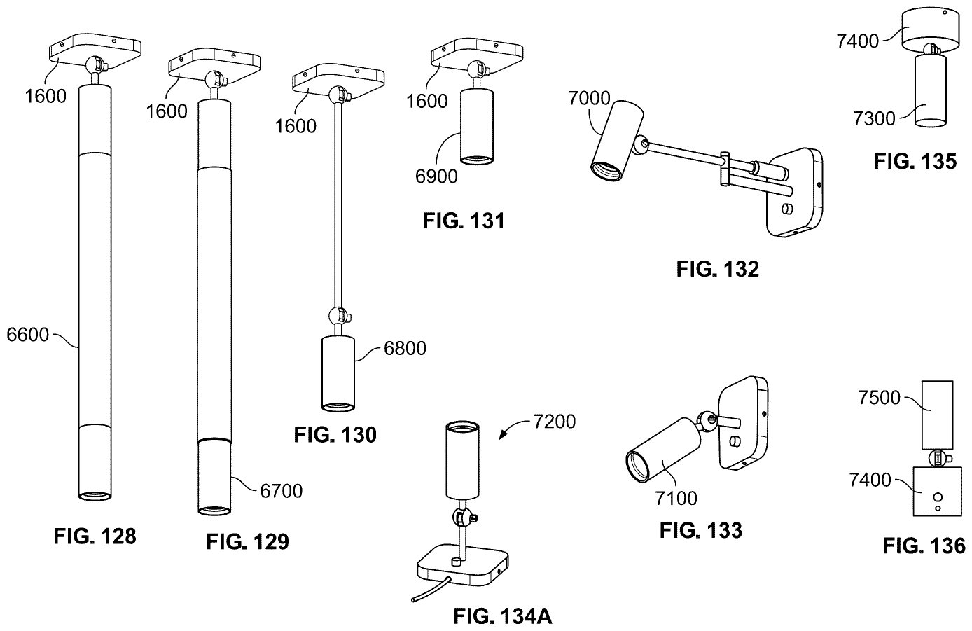

FIGS. 128-136 illustrate various light emitting attachments 6600-7400 fixable to a canopy for a modular lighting system. The attachments 6600-7400 can vary in length and design depending on a desired installation.

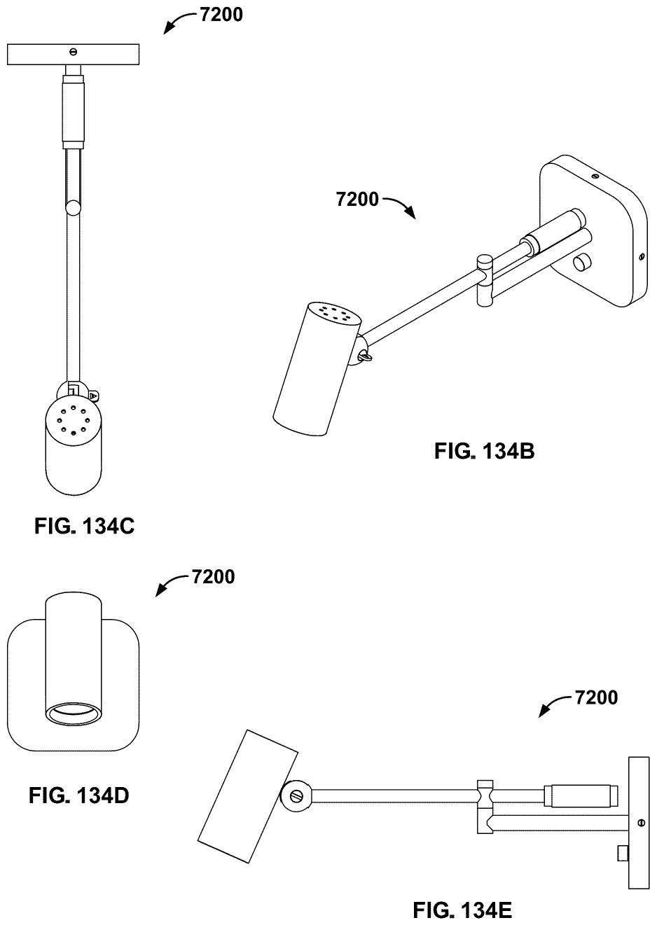

FIGS. 134A-134E depict various views of the light assembly 7200 that includes a base, canopy, articulatable arm and light source.

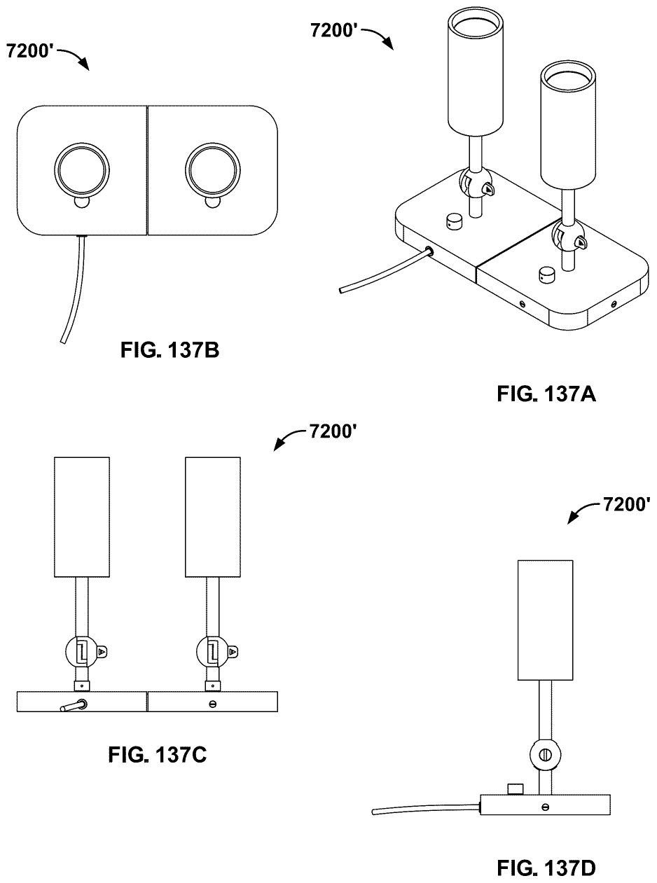

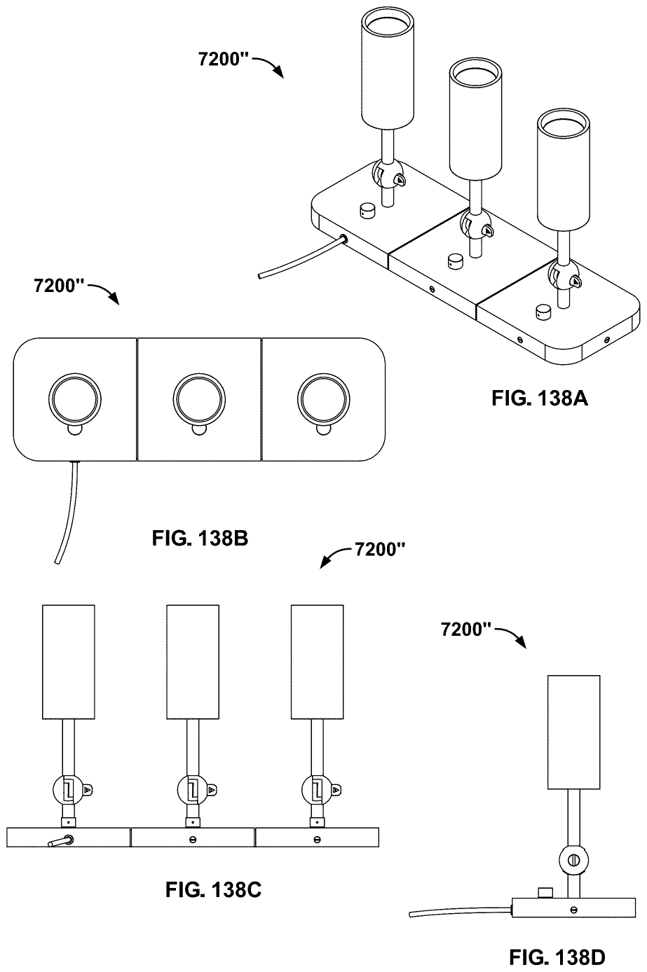

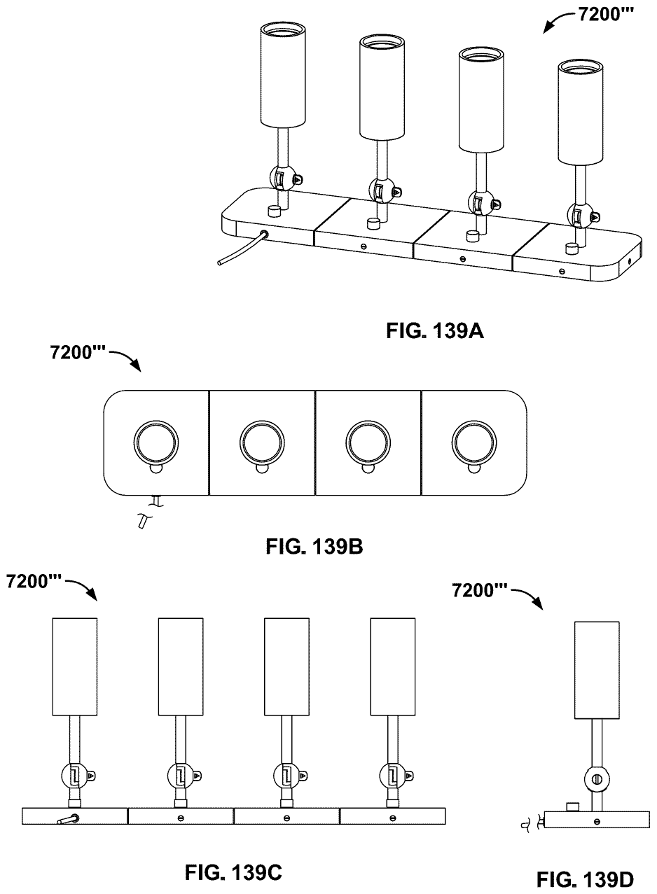

FIGS. 137A-139D depict light assemblies 7200′, 7200″, 7200″′ that re derivations of the modular light system 7200.

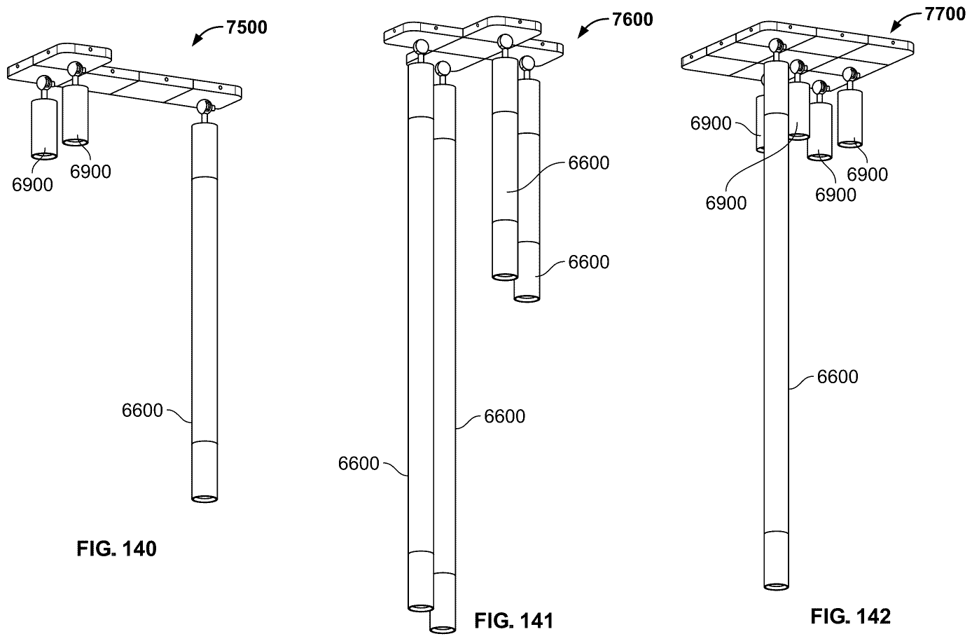

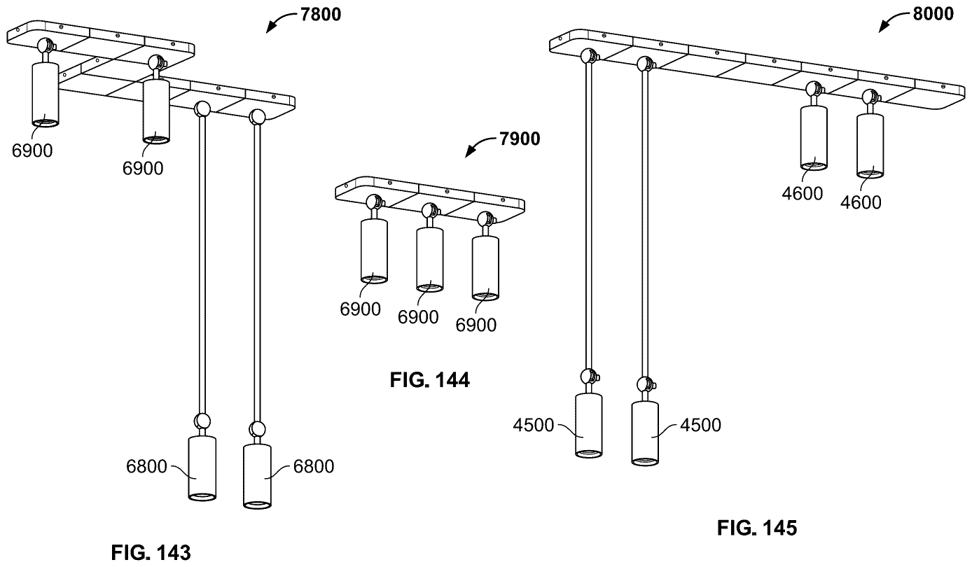

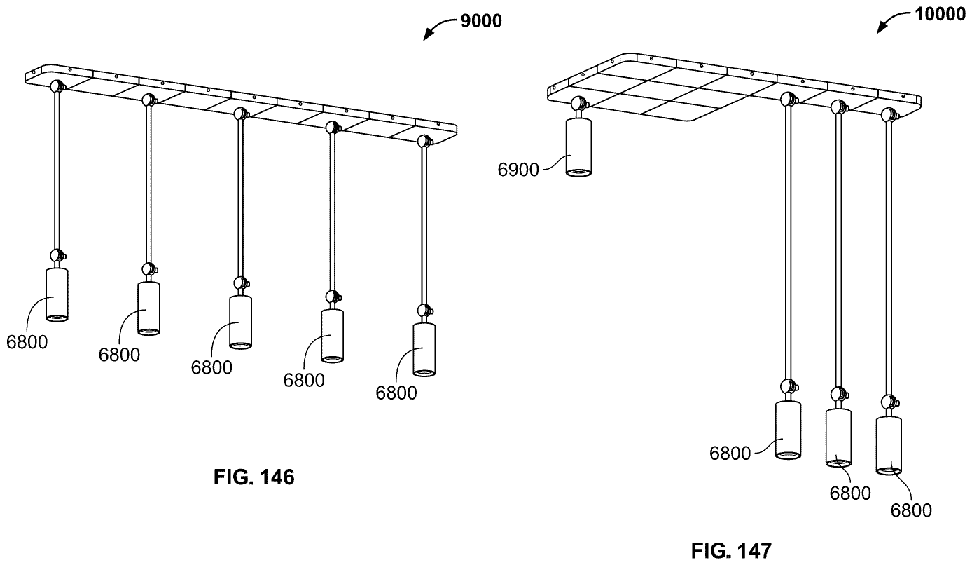

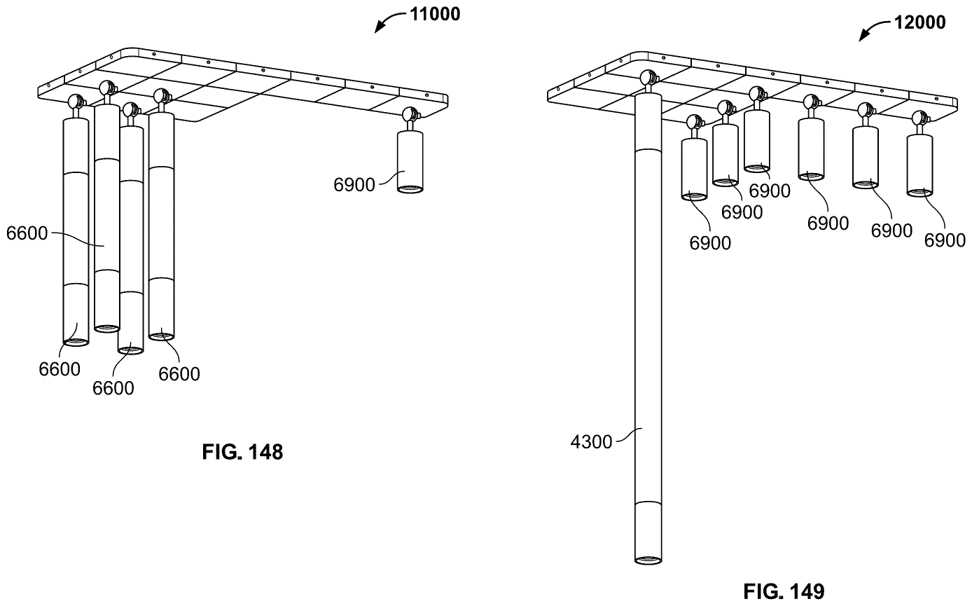

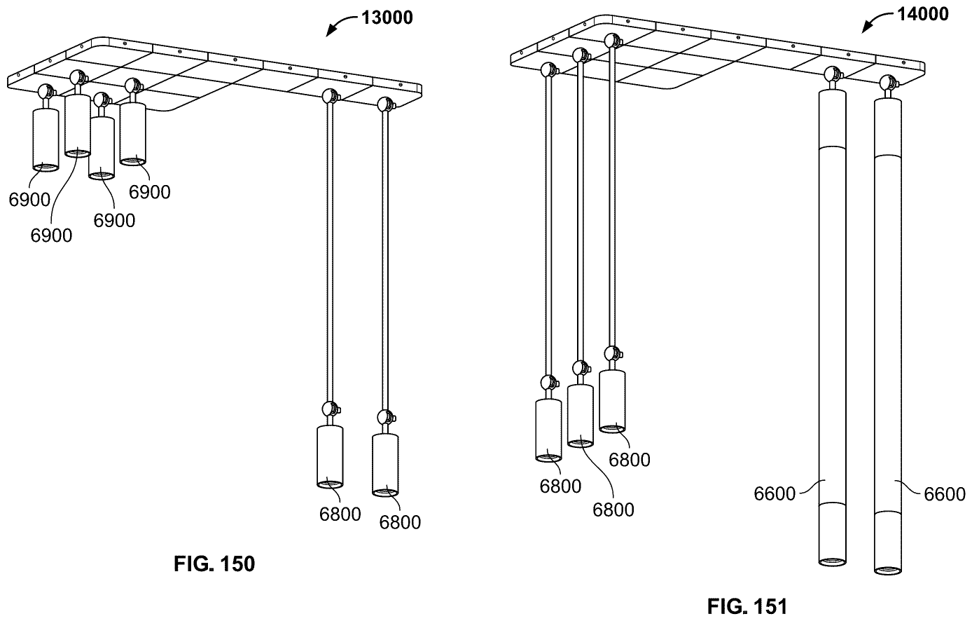

FIGS. 140-151 illustrate various views of modular lighting system assemblies 7500-14000. Here, a plurality of mounting plates are arranged adjacent to each other and fixed to each other, canopies are arranged over each mounting plate and fixed to the mounting plates and light emitting attachments are fixed to select canopies.

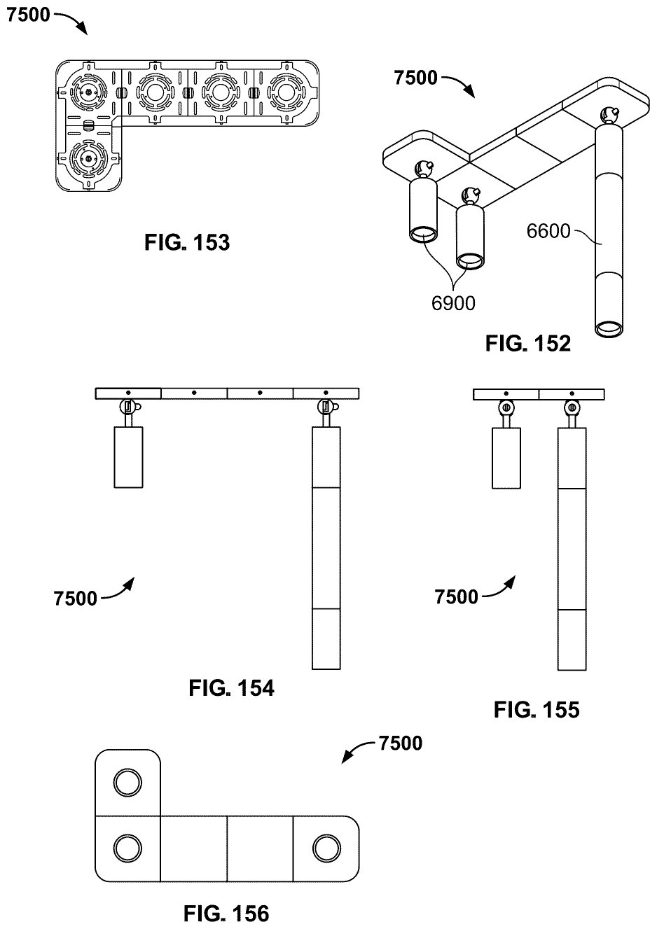

FIGS. 152-156 illustrate various views of the modular lighting system assembly 7500. Here, four mounting plates 100, 400, 500 are arranged adjacent to each other with a fifth mounting plate fixed adjacent to one of the linearly connected four other mounting plates, a canopy is arranged over each mounting plate and fixed to the respective mounting plate and light emitting attachments are fixed to select canopies.

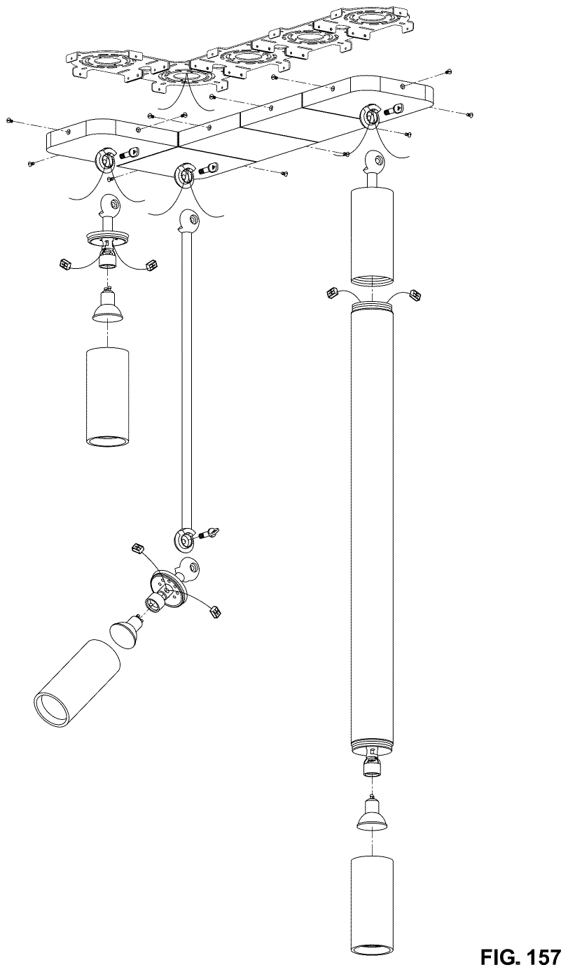

FIG. 157 depicts an assembly of the modular lighting system. As can be seen, the mounting plates 100, 400, 500 are fixed adjacent to each other and electrical wiring extends through at least one of the plates 100, 400, 500. The wiring is pulled through an opening in each canopy 700, 1200, 1300, that is to be associated with a light emitting attachment and connected to each light emitting attachment. The light emitting attachments are fixed to respective canopy 700, 1200, 1300.

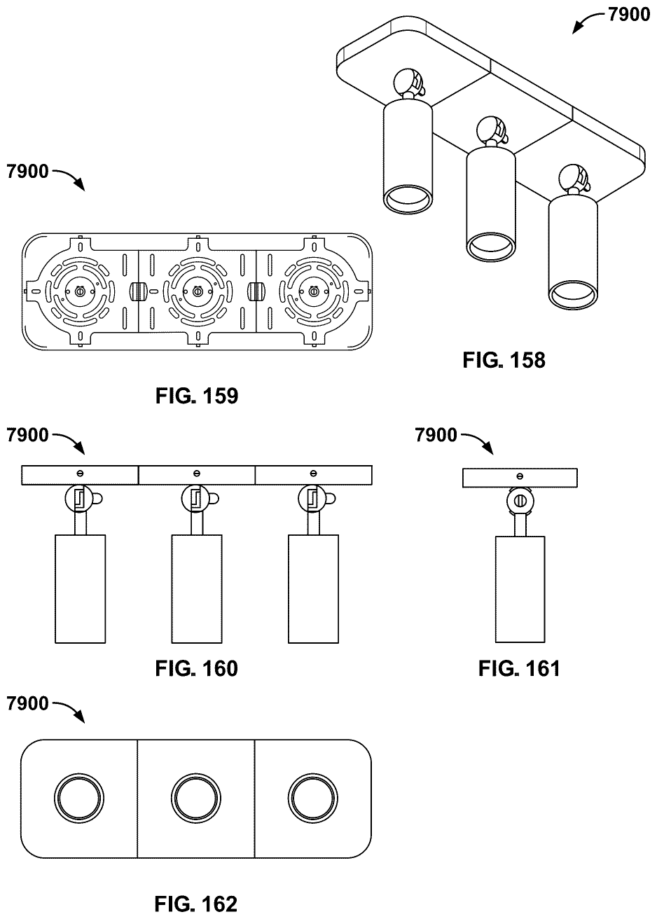

FIGS. 158-162 illustrate various views of another modular lighting system assembly 7900. Here, three mounting plates are arranged adjacent to each other and fixed to each other, a canopy is arranged over each mounting plate and fixed to the respective mounting plate and light emitting attachments are fixed to each canopy.

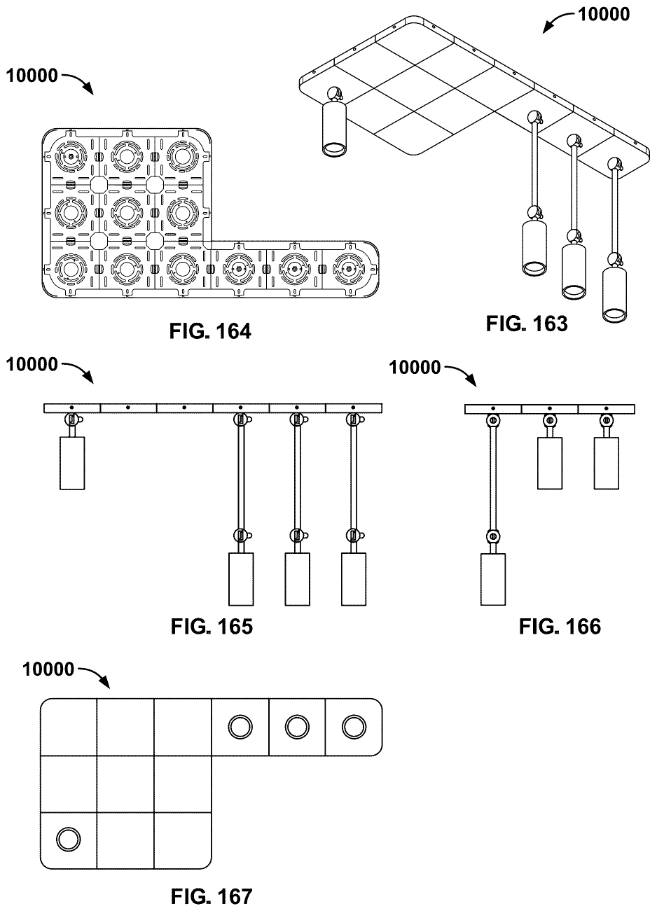

FIGS. 163-167 illustrate various views of another modular lighting system assembly 10000. Here, mounting plates are arranged adjacent to each other and fixed to each other in three rows including three mounting plated and associated canopies and one row including six mounting plates and associated canopies and light emitting attachments are fixed to select canopies.

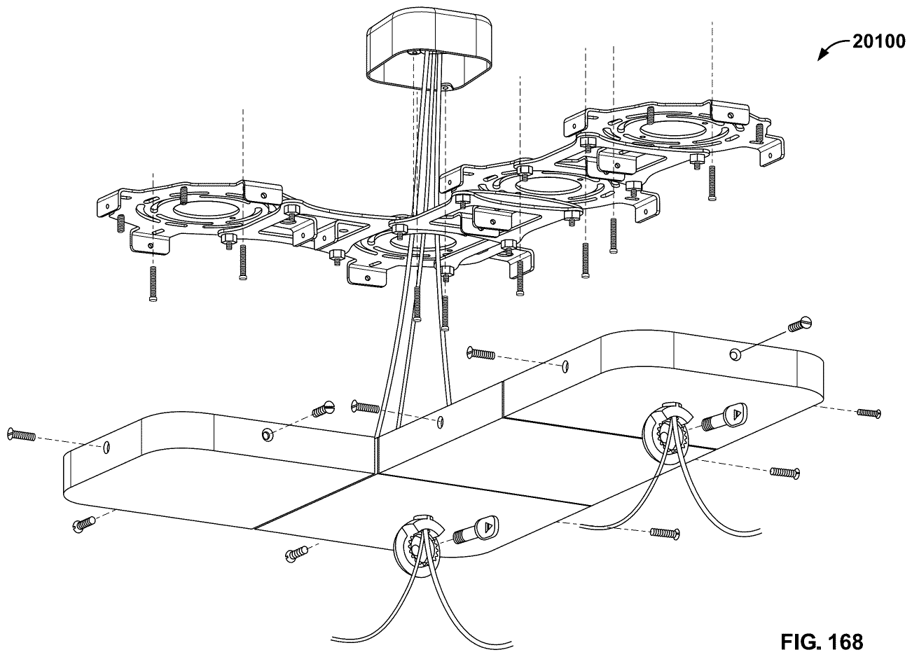

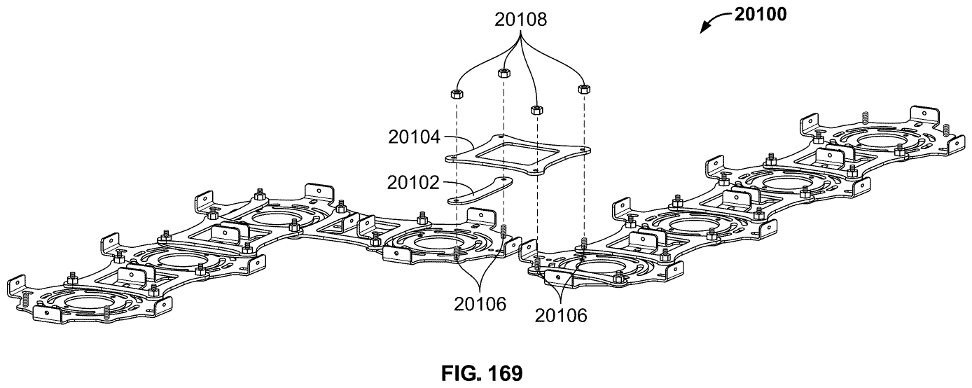

FIGS. 168-170 illustrate various stages of assembly of embodiments of modular lighting systems 20000, 21000, 22000. As shown in FIG. 168, after connecting mounting plates 20100 to each other by fasteners, a riser 20102, connector 20104 and fasteners 20106, 20108 (e.g., screw and nut) are affixed to the mounting plates 20100. Wires are then fed from a power source (e.g., via a junction box) through one or more mounting plates and canopies. The canopies are secured to the mounting plates with fasteners. As can be seen in FIG. 170, the canopies are affixed to each other with a male end and a female end connected to each other with the male end nested within the female end of the canopies.

Although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. It is to be understood that the phraseology or terminology employed herein is for the purpose of description and not of limitation. In addition, while several variations of the embodiments of the invention have been shown and described in detail, other modifications, which are within the scope of this invention, including, but not limited to, the substitutions of equivalent features, materials, or parts, will be readily apparent to those of skill in the art based upon this disclosure without departing from the spirit and scope of the invention.

What is claimed is:

1. A modular lighting system, comprising:
at least one mounting plate;
at least one canopy; and
at least one light source.

2. The modular lighting system of claim 1, wherein the at least one mounting plate includes a main body and a flange extending from each side of the main body in a same direction.

3. The modular lighting system of claim 1, wherein the at least one mounting plate includes at least a first mounting plate and a second mounting plate that are configured to be arranged adjacent to each other and fixable to each other.

4. The modular lighting system of claim 1, wherein the at least one canopy includes a main body and a plurality of sidewalls with the sidewalls extending in a same direction from the main body and extending along at least a portion of each side of the main body.

5. The modular lighting system of claim 1, wherein the at least one canopy is configured to be arranged over the least one mounting plate and fixed to the mounting plate.

6. The modular lighting system of claim 1, wherein the at least one canopy includes at least a first canopy and a second canopy that are configured to extend over the at least first mounting plate and the second mounting plate, respectively.

7. The modular lighting system of claim 1, wherein at least one canopy includes at least a first canopy and a second canopy, the first canopy having a recessed sidewall and the second canopy having a protruding sidewall that is configured to mate with the recessed sidewall.

8. The modular lighting system of claim 1, wherein the least one light source is fixed to the at least one canopy.

9. A modular lighting kit, comprising:
a plurality of mounting plates that are configured to be arranged adjacent to each other;
a plurality of canopies that are configured to extend over each of the mounting plates; and
at least one light source that is fixed to and extends from at least one of the canopies.

10. A method of assembling a modular lighting system comprising the following steps:
providing at least one mounting plate; at least one canopy; and at least one light source;
fixing the mounting plate to a surface;
arranging the canopy over the mounting plate; and
fixing the light source to the canopy.

11. The method of claim 10, further comprising the steps of providing a plurality of mounting plates, a plurality of canopies and at least one light source;
fixing a first one of the plurality of mounting plates to the surface;
arranging a second one of the plurality of mounting plates adjacent to the first one of the plurality of mounting plates and fixing the second one of the plurality of mounting plates to the surface;
arranging a first one of the plurality of canopies over the first one of the plurality of mounting plates and fixing the first one of the plurality of canopies to the first one of the plurality of mounting plates;
arranging a second one of the plurality of canopies over the second one of the plurality of mounting plates and fixing the second one of the plurality of canopies to the second one of the plurality of mounting plates; and
fixing the light source to one of the plurality of canopies.
